(19) United States
(12) Patent Application Publication
(10) Pub. No.: US 2022/0043904 A1
(43) Pub. Date: Feb. 10, 2022

(54) SYSTEMS AND METHODS FOR CONTROLLING SMART DEVICES

(71) Applicant: YUNDING NETWORK TECHNOLOGY (BEIJING) CO., LTD., Beijing (CN)

(72) Inventors: Binghui PENG, Beijing (CN); Hao TANG, Beijing (CN); Tao LI, Beijing (CN)

(73) Assignee: YUNDING NETWORK TECHNOLOGY (BEIJING) CO., LTD., Beijing (CN)

(21) Appl. No.: 17/451,873

(22) Filed: Oct. 22, 2021

Related U.S. Application Data
(63) Continuation-in-part of application No. PCT/CN2020/086661, filed on Apr. 24, 2020.

(30) Foreign Application Priority Data
Apr. 24, 2019 (CN) 201910333439.9
Apr. 24, 2019 (CN) 201910333750.3

(51) Int. Cl. G06F 21/46

(52) U.S. Cl. CPC G06F 21/46; G06F 2221/2141; G06F 2221/2137

(57) ABSTRACT

Systems and methods for controlling a smart device are provided. The methods may include acquiring a state switching instruction including first password information. The methods may further include acquiring information of a preset periodic password related to the smart device. The preset periodic password becomes valid each time after a predetermined time has passed. The methods may further include determining whether to switch a state of the smart device based on the information of the password and the information of the preset periodic password.

### CROSS-REFERENCE TO RELATED APPLICATIONS

This application is a continuation-in-part of International Application No. PCT/CN2020/086661, filed on Apr. 24, 2020, which claims priority to Chinese Patent Application No. 201910333750.3, filed on Apr. 24, 2019, and Chinese Patent Application No. 201910333439.9, filed on Apr. 24, 2019, the contents of each of which are incorporated herein by reference.

### TECHNICAL FIELD

The present application relates to the field of smart device control techniques, and in particular, relates to a method for controlling a smart device and a system for the same.

### BACKGROUND

With the progress in science and techniques, the method for controlling devices has changed from mechanical control to smart control. For example, for devices having multiple states such as a smart device, the method for switching the states has changed from mechanical control to smart control gradually. In order to make smart devices to be used more effectively, flexibly, and securely in complicated application scenarios, the present disclosure provides a method for controlling a smart device and a system for the same.

### SUMMARY

According to an aspect of the present disclosure, a system for controlling a smart device is provided. The system may include a storage device storing a set of instructions and one or more processors communicating with the storage device. When the set of instructions are executed, the one or more processors are configured to cause the system to: acquire a state switching instruction, the state switching instruction including first password information; acquire information of a preset periodic password related to the smart device, wherein the preset periodic password becomes valid once each time after a predetermined time has passed; and determine whether to switch a state of the smart device based on the information of the password and the information of the preset periodic password.

In some embodiments, the information of the preset periodic password may include a time of use indicating the predetermined time and a time range in which the preset periodic password is valid.

In some embodiments, the time of use may denote that the password is allowed to be valid once every specific months, every specific weeks, or every specific days.

In some embodiments, the predetermined time may relate to a periodic time interval of specific months. and a day number, the day number indicating one or more specific days within each month, wherein the preset periodic password becomes valid once, during the time range on one or more days corresponding to the day number, each time after the specific months have passed.

In some embodiments, the predetermined time may relate to a periodic time interval of specific weeks and a weekday number, the weekday number indicating one or more days within each week, wherein the preset periodic password becomes valid once, during the time range on one or more days corresponding to the weekday number, each time after the specific weeks have passed.

In some embodiments, the predetermined time may relate to a periodic time interval of specific days, wherein the preset periodic password becomes valid once, during the time range on one or more days, each time after the specific days have passed.

In some embodiments, to determine whether to switch a state of the smart device based on the information of the password and the information of the preset periodic password, the one or more processors may be configured to cause the system to: compare the first password information with the preset periodic password information to obtain a first comparison result; in response to the first comparison result that a password content of the first password information is the same as a password content of the preset periodic password, acquire an input time of the first password information; compare, based on the time of use of the preset periodic password, the input time with an effective time for the preset periodic password to obtain a second comparison result; and in response to the second comparison result that the input time is within the effective time for the preset periodic password, switch the state of the smart device based on the password content.

In some embodiments, the information of the preset periodic password may include a first working time and an effective period. The preset periodic password may start to be valid for the first time at the first working time. The preset periodic password may be invalid outside the effective period.

In some embodiments, the predetermined time may relate to specific weeks and a weekday number, the weekday number indicating one or more days within each week, wherein the preset periodic password becomes valid once, during the time range on one or more days corresponding to the weekday number, each time after the specific weeks have passed. To compare the input time with the effective time of the preset periodic password to obtain the second comparison result, the one or more processors may be configured to cause the system to: determine whether the input time conforms to the weekday number; in response to determining that the input time conforms to the weekday number, determine whether the input time conforms to the periodic time interval; and in response to determining that the input time conforms to the periodic time interval, obtain the second comparison result that the input time is within the effective time for the preset periodic password.

In some embodiments, to determine whether the input time conforms to the periodic time interval, the one or more processors are configured to cause the system to: determine a time difference between the first working time of the preset periodic password and the input time; determine a count of target weeks included in the time difference; determine a count of reference weeks in the periodic time interval; determine whether the count of target weeks is divisible by the count of reference weeks; and in response to determining that the count of target weeks is divisible by the count of reference weeks, determining that the input time conforms to the periodic time interval.

In some embodiments, the predetermined time may relate to specific months and a day number, the day number indicating one or more specific days within each month. The preset periodic password becomes valid once, during the time range on one or more days corresponding to the day number, each time after the specific months have passed. To compare the input time with the effective time of the preset periodic password to obtain the second comparison result, the one or more processors may be configured to cause the system to: determine whether the input time conforms to the day number; in response to determining that the input time conforms to the day number, determine whether the input time conforms to the periodic time interval; and in response to determining that the input time conforms to the periodic time interval, obtain the second comparison result that the input time is within the effective time for the preset periodic password.

In some embodiments, to determine whether the input time conforms to the periodic time interval, the one or more processors may be configured to cause the system to: determine a time difference between the first working time of the preset periodic password and the input time; determine a count of target months included in the time difference; determine a count of reference months in the periodic time interval; determine whether the count of target months is divisible by the count of reference months; and in response to determining that the count of target months is divisible by the count of reference months, determine that the input time conforms to the periodic time interval.

In some embodiments, the one or more processors are further configured to cause the system to: determine whether the input time is within the effective period; and in response to a determination that the input time is not within the effective period, delete the preset periodic password.

In some embodiments, the information of the preset periodic password may further include a suspending duration. The preset periodic password may be temporarily invalid during the suspending duration.

According to another aspect of the present disclosure, a system for generating a periodic password for a smart device is provided. The system may include a storage device storing a set of instructions and one or more processors communicating with the storage device. When the set of instructions are executed, the one or more processors may be configured to cause the system to: obtain, by a first electronic device, a user input indicating a password content and a time of use of the password content, wherein the time of use indicates that the password content is valid within a time range once each time after a predetermined time has passed; and generate, by the first electronic device, the periodic password based on the password content, the time of use, and a generation time related to the password content.

In some embodiments, to generate, by the first electronic device, the periodic password based on the password content, the time of use, and the generation time, the one or more processors may be configured to cause the system to: send, by the first electronic device at a sending time, a first part of the periodic password to the second electronic device, the first part of the password including the password content and the time of use; designate the sending time of the first part of the periodic password as the generation time; and send a second part of the periodic password to the second electronic device, the second part of the password including the generation time.

In some embodiments, the predetermined time may relate to a periodic time interval of specific months and a day number, the day number indicating one or more specific days within each month. The preset periodic password may be valid once, during the time range on one or more days corresponding to the day number, each time after the specific months have passed.

In some embodiments, the predetermined time may relate to a periodic time interval of specific weeks and a weekday number, the weekday number indicating one or more days within each week. The preset periodic password may be valid once, during the time range on one or more days corresponding to the weekday number, each time after the specific weeks have passed.

In some embodiments, the predetermined time may relate to a periodic time interval of specific days. The preset periodic password may be valid once, during the time range on one or more days, each time after the specific days have passed.

In some embodiments, the one or more processors are configured to cause the system to: receive, by the first electronic device, a notification from the second electronic device that indicates the second electronic device has received the first part and the second part of the periodic password; and determine, by the first electronic device, that the periodic password is successfully generated.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities, and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a diagram of an application scenario of a system for controlling a smart device provided by an embodiment of the present disclosure;

FIG. 2 is a flowchart of a method for controlling a smart device provided by an embodiment of the present disclosure;

FIG. 3 is a flowchart of a password generation method provided by an embodiment of the present disclosure;

FIG. 4 is a flowchart of a password generation method provided by an embodiment of the present disclosure;

FIG. 5 is a flowchart of a password verification method provided by an embodiment of the present disclosure;

FIG. 6 is a flowchart of a password verification method provided by an embodiment of the present disclosure;

FIG. 7 is a block diagram of a password generation device provided by an embodiment of the present disclosure;

FIG. 8 is a block diagram of a password generation device provided by an embodiment of the present disclosure;

FIG. 9 is a block diagram of a password generation device provided by an embodiment of the present disclosure; and

FIG. 10 is a block diagram of a password generation device provided by an embodiment of the present disclosure.

### DETAILED DESCRIPTION

The following description is presented to enable any person skilled in the art to make and use the present disclosure, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown but is to be accorded the widest scope consistent with the claims.

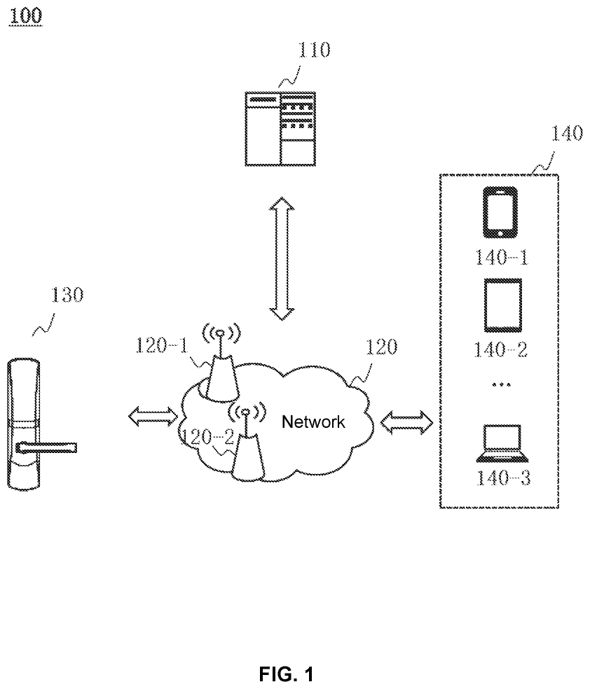

FIG. 1 shows a diagram of an application scenario of a system for controlling a smart device provided by an embodiment of the present disclosure. A smart device control system 100 can conduct the management of control privileges for the smart device. In some embodiments, the smart device may have more than one state, and the entities having control privileges (users or devices) can control it to switch between various states. For example, it is possible to carry password information in a control instruction, and when it is determined by the smart device after verification that the password information is valid, state switching is performed. The smart devices may include but not limited to vehicles, lockers, electrical appliances, smart locks, smart switches, adjusters, smart peepholes, smart monitoring devices (e.g., smart cameras), visual doorbells, etc. The smart device control system 100 can be widely applied to various life and production fields such as residential houses, office buildings, factories, schools, hospitals, hotels, and rented houses. As shown in FIG. 1, the smart device control system 100 includes at least a server 110, a network 120, a smart device 130, and a user terminal 140.

The server 110 can process data and/or information related to the control of the smart device 130 to execute one or more functions described in the present disclosure. In some embodiments, the server 110 may include one or more processors to process the related data and/or information. For example, the server 110 may acquire the preset password information and/or its attribute information set by the user terminal 140 associated with a user having a management privilege for the smart device 130. The attribute information may indicate the effective time, the suspending state, the valid way of entering, etc., corresponding to the password information. Also, for example, the server 130 may send the preset password information and attribute information to the corresponding smart device 130. Also, for example, the server 110 may acquire the state information of the smart device 130 through the network 120, and send the state information to the user terminal 140, so that the related user can understand the operation status of the smart device 130 timely. In some embodiments, the server 110 may also send a control instruction to the relevant smart device 130 upon request to control the smart device 130 to complete relevant state switching. In some embodiments, the server 110 may be a single server or a group of servers. The group of servers may be centralized or distributed (e.g., the server 110 may be a distributed system). In some embodiments, the server 110 may be local or remote. In some embodiments, the server 110 may be implemented on a cloud platform (i.e. a cloud server). Only as an example, the cloud platform may include a private cloud, a public cloud, a mixed cloud, a community cloud, a distribution cloud, between clouds, multiple clouds, etc, or any combinations thereof. In some embodiments, the server 110 may be implemented on a computing device. In some embodiments, the server 110 may be implemented on a mobile device.

The network 120 may facilitate the exchange of information and/or data. In some embodiments, one or more components in the system 100 (e.g., the server 110, the user terminal 140, and/or the storage) may transmit information and/or data to other component(s) in the system 100 via the network 120. For example, the server 110 may obtain/acquire information from the user terminal 140 via the network 120. In some embodiments, the network 120 may be any type of wired or wireless network, or a combination thereof. Merely by way of example, the network 120 may include a cable network, a wireline network, an optical fiber network, a tele communications network, an intranet, an Internet, a local area network (LAN), a wide area network (WAN), a wireless local area network (WLAN), a metropolitan area network (MAN), a wide area network (WAN), a public telephone switched network (PSTN), a Bluetooth™ network, a ZigBee™ network, a near field communication (NFC) network, a global system for mobile communications (GSM) network, a code-division multiple access (CDMA) network, a time-division multiple access (TDMA) network, a general packet radio service (GPRS) network, an enhanced data rate for GSM evolution (EDGE) network, a wideband code division multiple access (WCDMA) network, a high speed downlink packet access (HSDPA) network, a long term evolution (LTE) network, a user datagram protocol (UDP) network, a transmission control protocol/Internet protocol (TCP/IP) network, a short message service (SMS) network, a wireless application protocol (WAP) network, a ultra wide band (UWB) network, an infrared ray, or the like, or any combination thereof. In some embodiments, the network 120 may include one or more network access points. For example, the network 120 may include wired or wireless network access points such as base stations and/or internet exchange points 120-1, 120-2, . . . , through which one or more components of the system 100 may be connected to the network 120 to exchange data and/or information.

The smart device 130 may have more than one state and may be switched between various states based on an instruction. In some embodiments, the states of the smart device 130 may include an on state (i.e., working state), an off state, a sleep state, an operating state, etc. For example, the states of smart locks, lockers, smart switches, smart monitoring devices (e.g., smart cameras), visual doorbells, and smart peepholes may include the on state and the off state, and the states of vehicles, electrical appliances, and adjusters may include the on state, the off state, the sleep state, and the operating state. In some embodiments, the smart device 130 may also include one or more processors to process-related data and/or information. For example, the smart device 130 may verify control instructions. In some embodiments, the control instruction may contain password information, and the smart device 130 may acquire control instructions via an input device such as its keyboard, image acquisition device, biometric collection device, voice collection device, or the like and verify the control instructions (e.g., verify the password information therein), and state switching is completed when the verification result is “valid.” In some embodiments, the smart device 130 locally stores the password information for verifying control instructions (e.g., a preset periodic password, and the password information carried by a control instruction for verification may be an input password entered on the smart device by a user). In some embodiments, only in response to a determination that the input password in a control command is the same as the preset periodic password and a determination that the first input time of acquiring the input password is within the range of the time of use in which the preset periodic password takes effect once, the control command may be determined as valid and the state of the smart device 130 may be switched. For example, assuming that the smart device 130 includes a smart lock. When a control instruction is a state switching instruction for indicating that the smart lock is switched from the off state to the on state and the control instruction is valid, the smart lock may be switched from the off state to the on state.

In some embodiments, the preset periodic password may be password information that is effective once at a specific time interval and set in advance by a user having a management privilege (e.g., the owner of the smart device 130, which may be simply referred to as the administrator user) and stored on the server or inside the smart device 130. The process of generating a preset periodic password includes: receive the password content entered by a user and the time of use of the password content entered by the user, in which the time of use of the password content denotes that the password content is allowed to be effective once at a specific time interval and limits the range of the time of use of the once effective password content; and generate a periodic password based on the password content, the time of use of the password content, and attribute information, in which the attribute information is used for verifying whether the password is within the range of the time of use in which it is effective once when control is performed based on the password.

In some embodiments, the preset periodic password may be stored in advance on the server 110 by the administrator user, and the smart device 130 may communicate with the server 110 at a regular time to acquire the preset periodic password and store it locally. In some embodiments, the administrator user may also set the attribute information of the preset periodic password, so that the smart device 130 may also verify the control instruction based on the attribute information to diversify how the smart device 130 is managed to satisfy user demands in a better manner. In some embodiments, there may be multiple preset periodic passwords each having different attribute information, and the attribute information may include the generation time, the first trigger time, the effective time, the suspending state, the suspending duration, the input pathway, etc., of the corresponding preset periodic password. Thus, the administrator user may set preset periodic passwords with different attributes, and assign them to users having different privileges. In some embodiments, the smart device 130 may also generate one or more preset periodic passwords based on a built-in algorithm. Alternatively, the periodic password set locally by the user on the smart device is used. Specifically, after the user terminal generates a preset periodic password, the password may be sent to a smart device that is communicatively connected to the user terminal in an online or offline manner. For example, taking a user terminal and a smart lock that is communicatively connected to the user terminal as an example, the connection method between them may be NFC, Bluetooth network connection or the like, or LAN, GPRS, ZigBee network or the like, and when the user terminal sends a password to the smart lock, not only the password can be sent online using these connection methods, but also it is possible to generate and verify a password in the offline manner. In the case of offline password sending, an activation code or function code may be added to the beginning of the offline password generated by the user terminal to activate a relevant function of the smart lock, so that the user can control the state of the smart door lock after adding a periodic password locally on the smart lock. The specific contents and format of the activation code or function code may be selected depending on the actual situation, and are not limited to the embodiments of the present disclosure.

In some embodiments, the smart device 130 may have a number, position information, state information, etc. In some embodiments, the user terminal 140 or the server 110 distinguishes between different smart devices 130 by the numbers. In some embodiments, the smart device 130 may have an independent communication module. The communication module may be based on the communication functions of any one of the networks listed above or any combinations thereof.

In some embodiments, the user terminal 140 may include, but is not limited to, a smart cell phone 140-1, a tablet computer 140-2, a notebook computer 140-3, a desktop computer, a personal digital assistant (PDA), a handheld game console, smart glasses, a smart watch, a wearable device, a virtual display device, a display enhancement device, or the like, or any combinations thereof. The user terminal 140 may exchange data with other devices in the smart device control system 100 via the network 120. In some embodiments, the user terminal 140 may be a user terminal of the administrator user that is capable of communicating with the smart device 130 directly or indirectly (e.g., via a server). The user terminal associated with the administrator user may distribute one or more preset periodic passwords that it has generated to the user of the smart device, thereby efficiently distributing the privileges of use of the smart device to a relevant person. In some embodiments, the user terminal associated with the administrator user is also capable of communicating with the server 110 and storing the preset periodic password on the server 110. Alternatively, the user terminal 140 may also send a management instruction to the server 110 to update the attribute information of one or more preset periodic passwords. In some embodiments, the user terminal associated with the administrator user may also issue a periodic password to the smart device via a server connected with the smart device or via a gateway or another smart device connected with the smart device, or via a network connection of NFC, Bluetooth or the like directly. In some embodiments, the user terminal 140 may also be used for receiving the state information of the smart device 130 directly or via the server 110 to timely understand the operation state of the smart device 130.

In some embodiments, the server 110, the smart device 130, and the user terminal 140 may include one or more storages, respectively. Alternatively, an individual storage may be included in the system 100 for storing data and/or instructions. In some embodiments, the storage may include a mass storage, a removable storage, a volatile read-and-write memory, a read-only memory (ROM), or the like, or any combination thereof. Exemplary mass storage may include a magnetic disk, an optical disk, a solid-state drive, etc. Exemplary removable storage may include a flash drive, a floppy disk, an optical disk, a memory card, a zip disk, a magnetic tape, etc. Exemplary volatile read-and-write memory may include a random access memory (RAM). Exemplary RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. Exemplary ROM may include a mask ROM (MROM), a programmable ROM (PROM), an erasable programmable ROM (PEROM), an electrically erasable programmable ROM (EEPROM), a compact disk ROM (CD-ROM), and a digital versatile disk ROM, etc. In some embodiments, the storage may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

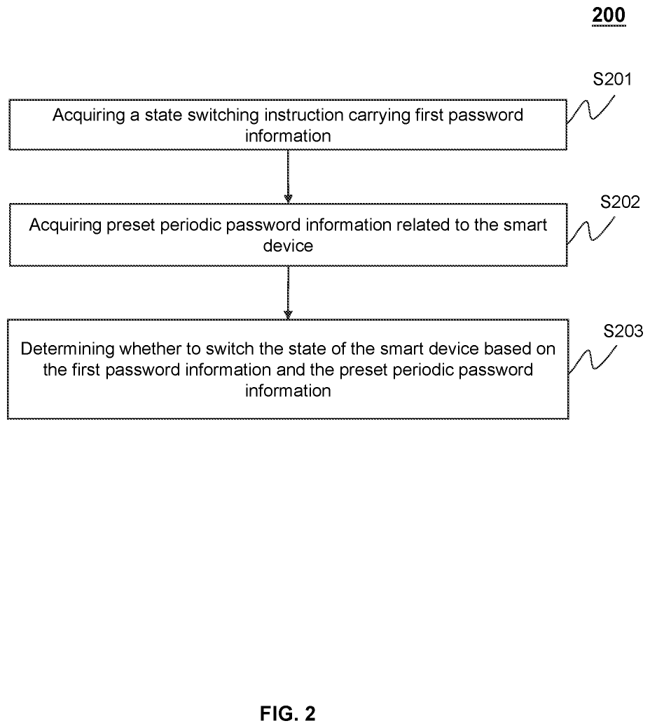

FIG. 2 shows a flowchart of a method for controlling a smart device provided by an embodiment of the present disclosure. In some embodiments, one or more steps in the process 200 may be implemented in the smart device control system 100 shown in FIG. 1. For example, one or more steps in the process 200 may be stored in a storage device in the form of instructions and called and/or executed by one or more processors. In some embodiments, the one or more processors may be processors in the smart device 130, so the process 200 may be implemented on the smart device 130.

In S201, the processor may acquire a state switching instruction carrying (or including) first password information.

In some embodiments, the state switching instruction may be an instruction or command to control the state of the smart device. In some embodiments, the smart device may be an electronic lock. For example, the smart device may be a door lock, a box lock, a cabinet lock, a garage lock, an equipment lock, a vehicle lock, etc. In some embodiments, the smart device may be a device equipped with an electronic lock or having a locking function. Such smart devices may include but not limited to a door, a lockbox, a safe, a vehicle (e.g., cars, bicycles, motorbikes), a smart switch, a smart phone, a computer, a laptop computer, a tablet computer, or the like. The smart device may also include other devices that can be operated using passwords, such as an alarm device, a smart peephole, smart monitoring devices (e.g., smart cameras), visual doorbells, etc. In some embodiments, the state switching instruction may be configured to control the state of the smart device based on a password type of a correct password that is entered by a user. The storage device may store different password contents and different password types corresponding to the password contents. Each password type may correspond to a specific state switching instruction. The processor may determine a password type based on the password content entered by the user, and then determine a state switching instruction corresponding to the password content. For example, the state switching instruction may be configured to direct the smart device to switch from a locked state to an unlocked state. As another example, the state switching instruction may be configured to direct the smart device to restore the factory default settings. As yet another example, the state switching instruction may be configured to eliminate a security alert of an alarm device. Alternatively, the user may input information regarding the state switching instruction along with the first password information. For example, the user may first press an “unlock” button, and then enter a password. The processor may determine the state switching instruction to be unlocking the smart device.

In some embodiments, the state switching instruction may also carry (or include) the first password information. In some embodiments, the first password information may include the first password, the smart device identification, the time when the user entered the first password, preset characters, and the like. In some embodiments, the user may include the owner, the manager, or a temporary user of the smart device.

In S202, the processor may acquire preset periodic password information related to the smart device.

In some embodiments, the preset periodic password related to the smart device may include a preset periodic password that is stored on the server or the processor of the smart device. In some embodiments, the preset periodic password remotely set for the smart device can be preset remotely by the owner or manager of the smart device through an electronic device (e.g., a cell phone, a tablet computer, etc.) based on the password content entered by any qualified person (here defined as a user) and the time of use of the password content entered by the user or acquired by an acquiring device. The acquiring device may include, for example, a code keyboard, a touch screen, a camera, a microphone, etc. The password content may include but not limited to a number, a fingerprint, a vein pattern, a sound, and an image (e.g., an image including biological features of a user, such as facial features). After the preset periodic password is generated, the preset periodic password may be sent to the server or a storage device of the smart device. The processor may acquire the preset periodic password information from the server or the storage device.

In some embodiments, the smart device 130 may also generate one or more preset periodic passwords based on a built-in algorithm. Alternatively, the periodic password locally set on the smart device by the user is used. Specifically, after the user terminal generates the preset periodic password, the password needs to be sent online or offline to a smart device that is communicatively connected to the user terminal. For example, taking a user terminal and a door lock connected with it as an example, the connection method between the two can be NFC, Bluetooth network connection, etc., or LAN, GPRS, ZigBee network, etc. When the user terminal sends the password to the door lock, not only can the password be sent online through these connection methods, but also the generation and verification of the password can be done offline. In the case of offline password sending, an activation code or function code can be added to the beginning of the offline password generated by the user terminal to activate the related functions of the smart door lock, so that the user can add a periodic password to the smart door lock and then be able to control the state of the smart door lock. The specific contents and format of the activation code or function code can be selected depending on the actual situation, which are not limited to the embodiments of the present disclosure.

In some embodiments, the password content entered by the user or acquired by an acquiring device is used to control the smart device. For example, the password content may be one of a number, a fingerprint, a sound, and an image that can control the smart device. In some embodiments, in order to acquire preset periodic password information related to the smart device, the smart device control system may receive the password content input by the user and the time of use of the password content input by the user, in which the time of use of the password content denotes that the password content is allowed to be valid once at a specific time interval (or each time when a predetermined time has passed), and limits the range of the time of use of the once effective password content; then, a password can be generated based on the password content, the time of use of the password content, and attribute information. The attribute information may be used for verifying whether the password is within the range of the time of use in which the password is effective once when control of the smart device is performed based on the password. The attribute information may include at least one of the following: the generation time of the periodic password information, the first working time of the periodic password, the effective period of the periodic password, a suspending duration, etc.

The preset periodic password may start to be valid for the first time at the first working time. The first working time may be set by the user. In some embodiments, the first working time may be used to determine whether the input time of the first password information conforms to the time of use of the preset periodic password. For example, when the user sets the preset periodic password on Monday, the user may set the first working time as Sunday, and a periodic time interval included in the time of use of the periodic password may be set as two weeks. Then the preset periodic password may be valid for the first time on Sunday, and be valid on Sunday each time after two weeks have passed. In some embodiments, the processor may set the first working time to be the same as the generation time of the periodic password according to a default setting or a user instruction.

The effective period of the periodic password indicates a period in which the periodic password can be used (but not necessarily be valid). The preset periodic password is invalid (or expired) outside the effective period. For example, if the password validity period of a preset periodic password is 2018.10.15-2018.11.15 but the local time is 2018.11.16, it means that the preset periodic password has expired and is invalid. In some embodiments, the processor may delete the expired preset periodic password.

The suspending duration indicates a period in which the periodic password is temporarily invalid. For example, when a house owner cancels the regular house cleaning service during a particular period but wants the regular house cleaning service to continue after the particular period, the house owner may set the particular period as the suspending duration. In the suspending duration, the preset periodic password is set to be a suspending state and remains invalid even during the time of use of the preset periodic password. If an inputted password content is the same as the preset password in the suspending duration, the processor may determine that the inputted password content is incorrect, and the state switching instruction may be rejected. After the suspending duration, the preset periodic password is set to be valid during the time of use.

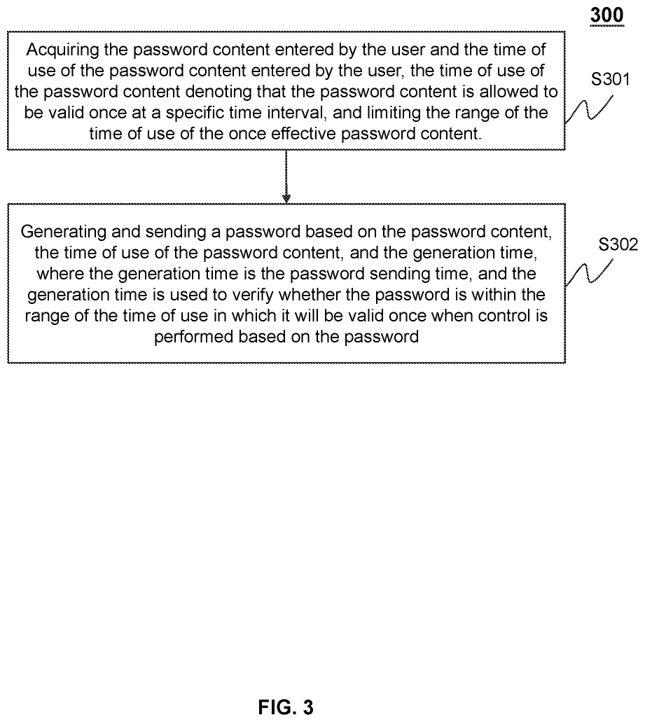

Taking the smart device as the first electronic device as an example, the password content can be acquired through the first electronic device and the first electronic device can be controlled based on the password content. Alternatively, the smart device may be a second electronic device that can communicate with the first electronic device, for example, directly or via a relay device (e.g., a server) so that the first electronic device can acquire the preset periodic password and send it to the second electronic device. The preset periodic password may be valid once at a specific time interval or each time after a predetermined time has passed. For more details about the generation process of the preset periodic password, refer to FIG. 3 and its related description, which will not be repeated here.

In some embodiments, the predetermined time may be a fixed time period, such as specific months, weeks, or days. For example, the periodic password may be valid on each Friday, then the predetermined time may be a week. If the periodic password is valid on the 5^{th} of each month, then the predetermined time may be a month. Alternatively, the predetermined time may be a varying period that changes based on a periodic time interval. In some embodiments, the predetermined time may relate to a periodic time interval of specific months and a day number. The day number may indicate one or more specific days within each month, such as the 5^{th} day of the month, the 10^{th} day of the month. In some embodiments, the day number includes information of a weekday number and a week number. The weekday number may indicate one or more specific days within each week, such as Monday, Friday. The week number may indicate a specific week within a month, such as the first week, the second week, etc. Merely by way of example, a specific day number may indicate the Monday of the first week of the month, the Friday of the second week of the month, or the like. The preset periodic password may be valid once, during the time range on one or more days corresponding to the day number, each time after the specific months have passed. For example, when the periodic time interval of specific months is two months, the day number indicates the Monday of the first week of each month, and the time range is 5:00 p.m. to 7 p.m., the preset periodic password may be valid between 5:00 p.m. to 7 p.m. on Monday of the first week of a corresponding month each time after two months have passed. Similarly, the predetermined time may relate to a periodic time interval of specific weeks and a weekday number. The preset periodic password may be valid on preset periodic password becomes valid once, during the time range on one or more days corresponding to the weekday number, each time after the specific weeks have passed. The predetermined time may also relate to a periodic time interval of specific days. The preset periodic password may be valid once, during the time range on one or more days, each time after the specific days have passed.

In S203, the processor may determine whether to switch the state of the smart device based on the first password information and the preset periodic password information.

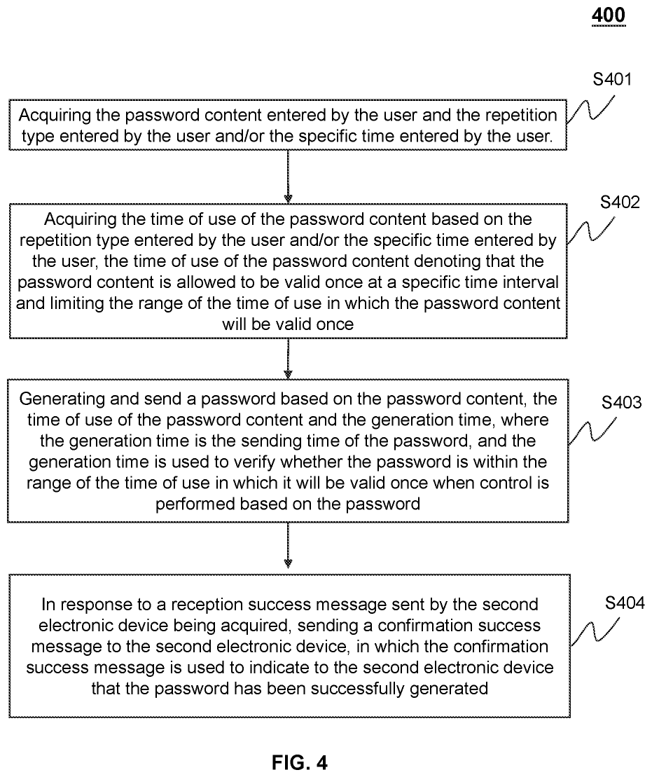

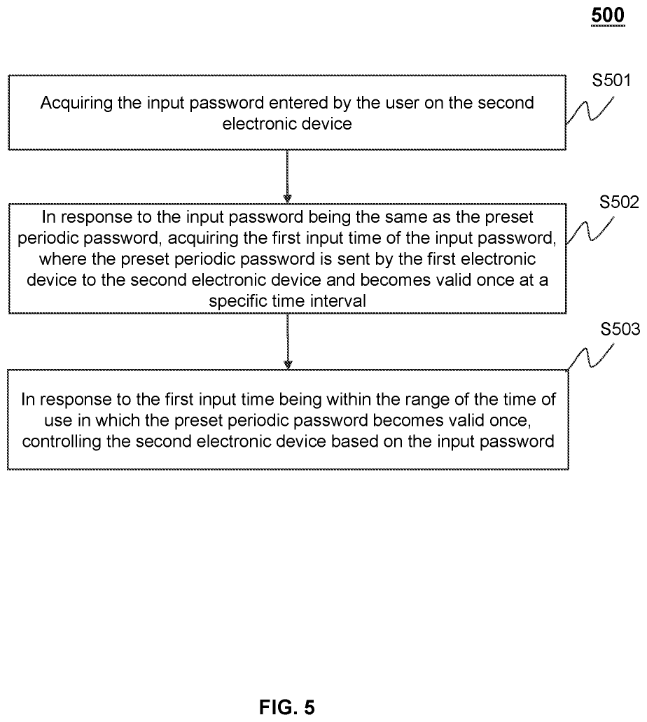

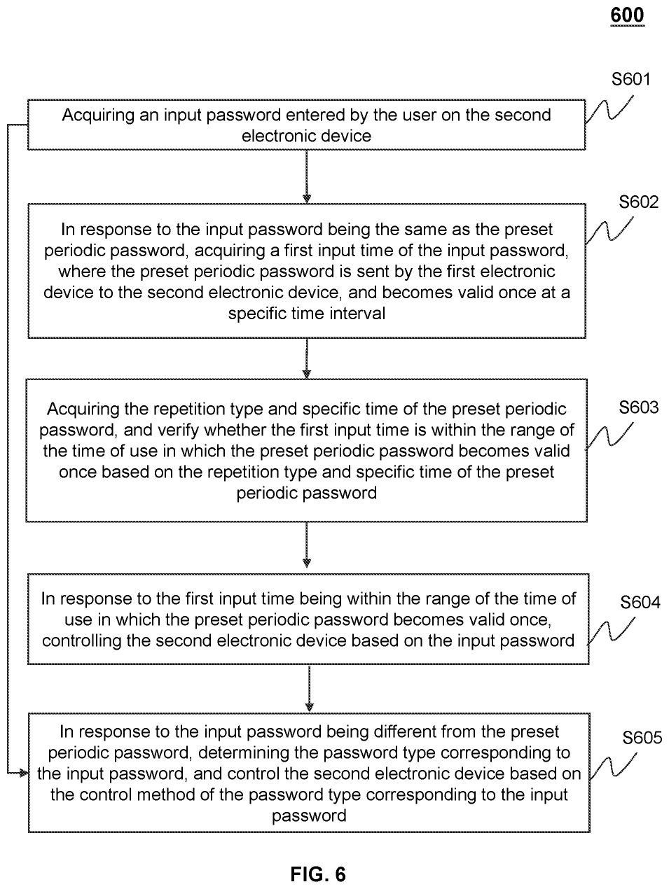

In some embodiments, the smart device may determine whether to switch the state of the smart device based on the first password information and the preset periodic password information. In some embodiments, the smart device may also determine whether to switch the state of the smart device based on the first password information and its attribute information and the preset periodic password and its attribute information. Specifically, the first password information and the preset periodic password information may be compared, and based on the comparison result, it is determined whether to switch the state of the smart device. If the input password (that is, the first password) is the same as the preset periodic password, the first input time of the input password is acquired; if the first input time is within the range of the time of use of the once effective preset periodic password, the state of the smart device is switched based on the input password (for example, the smart device is controlled to switch from the current state to another state (for example, from the off state to the on state)); on the contrary, if the first input time is not within the range of the time of use of the once effective preset periodic password, the state of the smart device will not be controlled. For more details about determining whether to perform state control on the smart device, refer to FIG. 3, FIG. 4, FIG. 5, and FIG. 6 and related descriptions, which will not be repeated here.

In some embodiments, a periodic password may be convenient for periodic events related to a need of state switching of the smart device, and a user may be to deal with different situations according to their needs using the periodic password. For instance, cleaning workers may come to the house regularly to do cleaning work. If the user informs the cleaning workers of the password to unlock the door, then the cleaning workers can come to the house even when the user is not at home. The periodic password is only valid at the time of use defined by the user so that the user does not have to worry about safety issues. If the cleaning workers come every other week on Friday morning, the user may set the use of the time of the periodic password as every other week's Friday morning from 9:00 a.m. to 11:30 a.m. As another example, the smart device may be a computer. A parent may use the periodic password to manage the use of the computer by a kid. By setting the time of use of the periodic password to every Saturday and Sunday from 9:00 a.m. to 9:00 p.m., the kid is allowed to unlock the computer and use the computer only on weekends, as required by the parent.

In some embodiments, the first password information included in the state switching instruction may be related to a specific user. Different users may use different password contents to unlock the smart devices. Therefore, the identity of the user may be recognized based on the password content entered by the user or acquired by an acquiring device. For example, the processor may compare the password content of the first password information with a set of preset passwords. If the password content of the first password information is the same as a preset password A, then the processor may determine that user A is attempting to control or change the state of the smart device.

In some embodiments, a user may use a mobile terminal to retrieval one or more unlocking records of a smart device such as a smart lock. For example, the mobile terminal may be operably connected to the smart lock through the Internet. In response to a retrieval request from the mobile terminal, the smart lock may retrieve and transmit one or more records (e.g., unlocking records, abnormal event records) of the smart lock to the mobile terminal. Exemplary unlocking records may include: an unlocking mode (e.g., in response to a verification codec input through the keypad, in response to a verification code received from a mobile terminal through Bluetooth, in response to a verification code received from a mobile terminal through NFC), an unlocking time, the identity of the person who is unlocking or has unlocked the smart lock, etc. The abnormal event records may correspond to a plurality type of events, such as password error a usage count of password exceeding a threshold, generating a warning notification, or the like, or any combination thereof. Exemplary abnormal event records may include an event type (e.g., password error), a time of the event (e.g., a start time of an event), or the like, or a combination thereof. In some embodiments, data related to the unlocking records may be uploaded to a cloud server through a mobile terminal operably connected to the smart lock. The connection between the mobile terminal and the smart lock may be established based on a wired connection or a wireless connection.

In some embodiments, the smart device may include a camera or may be communicatively connected to a camera. The camera may be configured to take a picture and/or record a video of the user who is trying to switch the state of the smart device or who has switched the state of the smart device. For instance, the camera may usually work under a low-energy-consuming state (e.g., only taking a low-resolution picture regularly at predetermined time intervals and/or record a low-resolution video). When the camera detects that a person is near the smart device, the camera may automatically switch to a normal state (i.e., a high-energy-consuming state) to take a high-resolution picture of the user and/or record a high-resolution video of the user. Alternatively, after the processor determines to switch the state of the smart device, the processor may send an instruction to the computer to take a picture and/or record a video of the user. In some embodiments, the picture taken by the camera and/or the video recorded by the camera may be transmitted to the user of the user terminal.

In some embodiments, second password information is carried (or included) in the state switching instruction. After the preset permanent password information related to the smart device is acquired, if the second password information is the same as the preset permanent password, the state of the smart device can be switched based on the second password information. The preset permanent password is permanently valid password information preset on the server or processor.

In some embodiments, the third password information is carried in the state switching instruction. After the preset one-time password information related to the smart device is acquired, if the third password information is the same as the preset one-time password, the second input time of the third password information is acquired. If the second input time is within the range of the time of use of the preset one-time password, the state of the smart device can be switched based on the input password, and the preset one-time password is once valid password information preset on the server or processor.

In some embodiments, the state switching instruction may include just one set of password information related to a user input. As used herein, the terms “first password information”, “second password information”, and “third password information” may refer to the same password information included in the state switching instruction. Use of the terms “first password information”, “second password information”, and “third password information” is merely intended for the convenience of describing the password information corresponding to different password types (e.g., a periodic password, a permanent password, or a one-time password).

It should be noted that the foregoing description of the process 200 is only for example and description, and does not limit the scope of the present disclosure. For those skilled in the art, various modifications and changes can be made to the process 200 under the guidance of the present disclosure. However, these modifications and changes are still within the scope of the present disclosure. In some embodiments, by determining whether to switch the state of the smart device based on the first password information and the preset periodic password information, the control of the smart device based on the periodic password can be realized, which satisfies the user requirement of controlling the smart device once at a specific time interval.

FIG. 3 shows a password generation method provided by an embodiment of the present disclosure, which is applied to a first electronic device (e.g., the user terminal 140 in FIG. 1) for generating a password (i.e., a preset periodic password) with a time of use, so that the password with the time of use meets the user requirement of controlling the controlled device at a certain interval. The process is as shown in FIG. 3 and can include the following steps.

In S301, the processor may acquire the password content entered by the user (or acquired by an acquiring device) and the time of use of the password content entered by the user, the time of use of the password content denoting that the password content is allowed to be valid once at a specific time interval (or each time after a predetermined time has passed), and limiting the range of the time of use of the once effective password content.

It can be understood that the password content is used to control the controlled device (e.g., the smart device 130 in FIG. 1) if the password content is determined to be valid. For example, the password content may be at least one of a number, a fingerprint, a vein pattern, a sound, and an image (e.g., an image including biological features of a user, such as facial features) that can control the controlled device. The device may be a first electronic device. That is, the password content is acquired through the first electronic device and the first electronic device is controlled based on the password content. Alternatively, the device may be a second electronic device capable of communicating with the first electronic device, for example, a second electronic device communicating with the first electronic device directly or via a relay device, so that the first electronic device can acquire the password content and send it to the second electronic device.

And while acquiring the password content, the processor also acquires the time of use of the password content. The time of use of the password content is used to limit the password content to be effective for many times periodically. In some embodiments, the so-called “effective for many times periodically” means taking effect (or being valid) once every a specific time (the specific time denotes the repetition interval) and the range of the time of use in which it will be valid once.

In some embodiments, the password content may be valid each time after a predetermined time has passed. The predetermined time may be a fixed duration or a varying duration, as described in connection with operation S202.

In some embodiments, the specific time interval may be one of specific months, specific weeks, and specific days. The range of the time of use of being effective once depends on the specific time interval. For example, if the time of use of the password content denotes that the password content is allowed to be valid once every specific months, the time of use of the password content also limits the date (or day number) when it will be valid once and the single-day effective time. The date when it will be valid once and the single-day effective time limit the range of the time of use in which it will be valid once. In other words, the time of use of the password content may also limit the date when the password content becomes effective in the specific months and the effective time at that date, in addition to the limitation that the repetition interval is specific months. The “specific months” is used to indicate the number of months as an interval.

For example, the interval of specific months can be any one from one month to N months, where N is a natural number and the value of N is greater than or equal to 1, and the date can be at least one of the 1st, 2nd, 3rd, . . . , and 31st. The date can be multiple days or a single day. For example, the date is the 1st, or the dates are the 1st, the 2nd and the 3rd. The single-day effective time is the effective time corresponding to the effective date, which is limited by the start time and the end time. If there are multiple dates when it will be valid once, the single-day effective times of the multiple dates can be the same or different. For example, the single-day effective time may be one or more hours, and the single-day effective time may also be specifically limited to minutes and seconds. Alternatively, a unified time is set for the single-day effective time. For example, the single-day effective time may be set to 13:00-19:00, so that it is unnecessary to enter the single-day effective time each time the time of use is entered. The specific settings of specific months, dates and single-day effective time will be determined by the user independently, and will not be explained here.

If the time of use of the password content denotes that the password content is allowed to be valid once every specific weeks, the time of use of the password content also limits on which day of a week it will be valid once and the single-day effective time, which limit the range of the time of use in which it will be valid once. In other words, the time of use of the password content may also limit on which day of a week in the specific weeks the password content is made effective and the effective time on that day, in addition to the limitation that the repetition interval is specific weeks. The “specific weeks” is used to indicate the number of weeks.

The interval of specific weeks may be one from one week to M weeks, where M is a natural number and the value of M is greater than or equal to 1. The day of a week may represent multiple days or a single day. For example, the day of a week may be one or more from Monday to Sunday. For the description of the single-day effective time, refer to the above description, which will not be repeated In some embodiments.

If the time of use of the password content denotes that the password content is allowed to be valid once every specific days, the time of use of the password content also limits the single-day effective time, and then the single-day effective time limits the range of use in which it will be valid once. In other words, in addition to the limitation that the repetition interval is specific days, the time of use of the password content may also limit the single-day effective time of the use of the password content. “Every specific days” is used to limit the number of days as an interval, which may be, for example, one of one day to X days, where X is a natural number and the value of X is greater than or equal to 1. For the description of the single-day effective time, refer to the above description, which will not be repeated In some embodiments.

The following is the description of examples of the specific months, specific weeks and specific days as intervals mentioned above. For example, if the interval is specific months, the form of the time of use of the password content may be, but is not limited to, 7:00 to 17:00 on the 1st, 3rd, and 4th every two months. The time of use of the password content denotes that every 2 months, the password content can be used on the 1st, 3rd, and 4th, and the password content can be used for controlling the controlled device from 7:00 to 17:00 on the 1st, 3rd, and 4th. For example, if the generation time (e.g., a generation timestamp) is Oct. 12, 2018, the password content will be valid for the first time from 7:00 to 17:00 on the 1st, 3rd, and 4th of January 2019 (the so-called “be valid” means that the controlled device can be controlled based on the password content), for the second time from 7:00 to 17:00 on the 1st, 3rd, and 4th of March 2019, for the third time from 7:00 to 17:00 on the 1st, 3rd, and 4th of May 2019 and so on, so that the effectiveness of the password content can be repeated periodically.

For example, if the interval is specific weeks, the form of the time of use of the password content may be, but is not limited to, 8:00 to 12:00 on Friday every 3 weeks. The time of use of the password content denotes that every 3 weeks, the password content can be used to control the controlled device from 8:00 to 12:00 on Friday. It depends on the generation timestamp on which Friday of the specific week it will be valid. For details, refer to the above description, which will not be explained here.

For another example, if the interval is specific days, the form of the time of use of the password content may be, but is not limited to, 13:00 to 19:00 every 5 days. The time of use of the password content denotes that every 5 days, the password content will be valid from 13:00 to 19:00. It also depends on the generation timestamp on which specific day it will be valid from 13:00 to 19:00. For details, refer to the above description, which will not be explained here.

It can be seen from the above examples that the time of use of the password content can contain information such as the repetition type, repetition period, repetition interval, start time and end time at the same time. The repetition type is used to denote that the password content is repeated in one of the following ways: months, weeks, and days. The repetition period is used to limit the date when it will be valid each time. For example, the repetition period is the 1st, 3rd, and 4th of each effective month for the 7:00 to 17:00 on the 1st, 3rd and 4th every 2 months mentioned above. The repetition interval limits the time interval between two adjacent times of taking effect. For example, 2 months in the above example is the repetition interval. The start time and end time are the beginning and end of the single-day effective time, respectively. The repetition type, repetition interval, etc. can be preset on the first electronic device, and the user selects the information that can be used as the information of the time of use of the password content entered this time from the preset repetition type, repetition interval and other information. Of course, the user can input the repetition type and repetition interval and other information. These will be described later in conjunction with the drawings.

In S302, the processor may generate and send a password based on the password content, the time of use of the password content, and the generation time, where the generation time is the password sending time, and the generation time is used to verify whether the password is within the range of the time of use in which it will be valid once when control is performed based on the password.

In some embodiments, the method of generating the password is: the password is composed of the password content, the time of use of the password content, and the generation time; specifically, the password content and the time of use of the password content are used as the first part of the password, and the first part of the password is sent to the second electronic device, and the sending time of the first part is recorded as the generation time, the generation time (e.g., a timestamp) is used as the second part of the password, and the second part of the password is sent to the second electronic device.

That is, although the password is composed of the password content, the time of use of the password content and the generation time, the generation time is the time when the password content and the time of use of the password content are sent, so that the parts of the password can be sent separately. For example, first the password content and the time of use of the password content are sent as the first part, and then the sending time of the first part is sent as the generation time. Alternatively, after triggering the sending of the password content and the time of use of the password content, wait for a preset time (depending on the actual application). And the time when the sending is triggered is used as the sending time of the first part. Thus, the generation time can be sent to the second electronic device along with the password content and the time of use of the password content.

In some embodiments, the generation time may be used to verify whether the time when the password was entered on the controlled device is within the range of the time of use in which the password is effective (or valid) once so that whether the password for controlling the controlled device is valid can be determined and periodic control of the controlled device may be realized using a password. Regarding how to verify it, more explanations will be made with reference to the drawings later.

In some embodiments, the processor may obtain a first working time of the preset periodic password. The preset periodic password may start to be valid for the first time at the first working time. In some embodiments, the first working time may be set by the user or may be set by the processor according to a default setting. In some embodiments, the first working time may be set as the same as the generation time of the periodic password. The first working time may be used to determine whether the time when the password was entered on the controlled device is within the range of the time of use in which the password is valid.

It can be seen from the above technical solution that after the password content is entered by the user (or acquired by an acquiring device) and the time of use of the password content entered by the user are acquired, a password is generated based on the password content, the time of use of the password content and the generation time, in which the time of use of the password content denotes that the password content is allowed to be valid once at a specific time interval, and limits the range of the time of use in which the password content will be valid once. This means that the password generated based on the password content is a periodic password, thereby adding another type of password on the basis of the existing permanent password and one-time password. Thus, it is possible to satisfy the user requirement of controlling the controlled device (for example, the second electronic device capable of communicating with the first electronic device) once at a specific time interval by this type of periodic password.

FIG. 4 shows another password generation method provided by an embodiment of the present disclosure, which is used to add the repetition type input by the user and/or the specific time input by the user into the password. The process is as shown in FIG. 4. It may include the following steps.

In S401, the processor may acquire the password content entered by the user (or acquired by an acquiring device) and the repetition type entered by the user and/or the specific time entered by the user.

In S402, the processor may acquire the time of use of the password content based on the repetition type entered by the user and/or the specific time entered by the user, the time of use of the password content denoting that the password content is allowed to be valid once at a specific time interval and limiting the range of the time of use in which the password content will be valid once.

The repetition type is used to denote that the password content is repeated in months, weeks, or days, so that the time of use of the password content is limited by the repetition type entered by the user and/or the specific time entered by the user. In this way, the user enters the repetition type and/or the specific time so that the user is enabled to freely and flexibly set the time of use.

In some embodiments, the specific time input by the user is the above repetition interval. For example, if the time of use of the password content is Wednesday every 4 weeks, the specific time is 4 weeks. The time of use of the password content is limited by the user input to satisfy the actual requirements for the time of use of the password content. In addition to the features of the repetition type and the specific time that denotes the repetition interval can be input by the user, the repetition period, start time and end time on which the acquisition of the time of use is based can also be input by the user, so that the repetition type, repetition interval, repetition period, start time and end time may be included the time of use of the password content. Refer to the foregoing method embodiment for the description of the repetition type, repetition interval, repetition period, start time, and end time, which will not be described In some embodiments.

The method for the user to enter the password content and time of use may be but is not limited to: displaying an interface in the display area of the first electronic device, which provides controls for entering the password content and time of use, so that the user can enter the password content and time of use through these controls. Of course, the password content and time of use can also be directly manually input by the user without the interface, or after a voice carrying the password content and time of use therein is acquired, the password content and time of use can be recognized from the voice, or an image containing the password content and the time of use can be collected by the first electronic device. This embodiment does not limit the input method of the password content and time of use.

In S403, the processor may generate and send a password based on the password content, the time of use of the password content and the generation time, where the generation time is the sending time of the password, and the generation time is used to verify whether the password is within the range of the time of use in which it will be valid once when control is performed based on the password.

Operation S403 may be performed in a manner similar to operation S302 in the execution process and principle, which will not be repeated here. Here, a brief description of the components of the password is provided. In some embodiments, the components of the password include: the password content, the time of use of the password content, and the generation time (e.g., a timestamp), in which the time of use of the password content includes: the repetition type, the repetition period, the repetition interval, the start time and the end time, as shown in Table 1, which gives explanation by taking the repetition by months as an example.

TABLE 1
Time of use of password content and generation timestamp

| create_time | repeat_interval | repeat_period | end_hour | start_hour | repeat_type |
|---|---|---|---|---|---|
| 15 byte-12 byte | 11 byte | 10 byte~7 byte | 6 byte~4 byte | 3 byte~1 byte | bit1~bit0 |

As can be seen in Table 1, repeat_type is the repetition type, which uses the 2 bits bit 0 and bit 1 of byte 0 of the password; start_hour is the start time, which uses bytes 1-3 of the password; end_hour is the end time, which uses bytes 4-6 of the password; repeat_period is the repetition period, which uses bytes 7-10 of the password; repeat_interval is the repetition interval, which uses byte 11 of the password; and create_time is the generation timestamp, which uses bytes 12-15 of the password.

It can be seen from Table 1 that the password generated In some embodiments has been added with the time of use of the password content and the generation timestamp compared to the permanent password, and has been added with fields other than the start time and the end time compared to the one-time password. In actual applications, by adding each field shown in Table 1 after the password content, different types of passwords can be generated by the first electronic device. The specific password type depends on whether the contents of the fields shown in Table 1 are empty or not. If all are empty, it is a permanent password. If all are empty except for the start time and end time, it is a one-time password. And if each field is not empty, it is the type of password provided In some embodiments.

In addition to adding the fields shown in Table 1 after the password content to meet the requirements for different types of passwords, In some embodiments, a reserved field may also be added to meet the need to add information carried by the password later. In addition, for repeat_type, the following settings can also be used to limit whether the password is repeated by months, weeks, or days, such as:
01=pwd_repeat_day_type, which represents that the password is repeated by days;
10=pwd_repeat_week_type, which represents that the password is repeated by weeks;
11=pwd_repeat_month_type, which represents that the password is repeated by months.

When it is repeated by days, the range of the time of use in which it will be valid once includes: 1 day (indicating that the range of the time of use is within one day)+single-day effective time (including the start time and end time)+password validity period (indicating the final time of use of the password; if the period expires, the password will become invalid; in practice, the password will be valid permanently by default), and the spaces used by these parts are 0 bits, 6 bytes, and 0 bits, respectively.

If it is repeated by weeks, the range of the time of use in which it will be valid once includes: multiple days of a week+single-day effective time+password validity period. The spaces used by these parts are 7 bits, 6 bytes, and 0 bits, respectively, and the 7 bits can be used to record whether it is effective from Monday to Sunday. Specifically, the specific day of a week on which it will be valid can be specified by the way of a preset numerical value. For example, the preset numerical value is 1. When one of the data of the 7 bits is 1, it means that the password will be effective on the day corresponding to that bit. For example, the data of the 7 bits corresponds to Monday to Sunday from 0 to 6 respectively, and if bit 3 in the 7-bit data is 1, it means that the password will be valid on Thursday.

If it is repeated by months, the range of the time of use in which it will be valid once includes: multiple numbers+single-day effective time+password validity period. The spaces used by these parts are 32 bits, 6 bytes, and 0 bits, respectively. The 32 bits is used to record on which day of a month it will be valid. For details, refer to the description of repetition by months.

Here, it should be noted that if it is repeated by weeks, repeat_period uses byte 7 of the password, repeat_interval uses byte 8 of the password, and create_time uses bytes 9-12 of the password; if it is repeated by days, repeat_period uses bit 0 of byte 7 of the password, and the rest are the same as those of the repetition by weeks.

In S404, in response to a reception success message sent by the second electronic device being acquired, the processor may send a confirmation success message to the second electronic device, in which the confirmation success message is used to indicate to the second electronic device that the password has been successfully generated.

In some embodiments, the reception success message may be a notification that the second electronic device has received the information of the periodic password (e.g., the first part and the second part of the periodic password).

That is, after the first electronic device generates the preset periodic password, it needs to send the password online or offline to the second electronic device that is communicatively connected to the first electronic device. For example, if the first electronic device is a user terminal and the second electronic device is a door lock that is communicatively connected to the user terminal, the connection method between the two can be NFC, Bluetooth network connection, etc., or LAN, GPRS, ZigBee network, etc., and when the user terminal sends a password to the door lock, not only can the password be sent online through these connection methods, but also the generation and verification of the password can be done offline. When offline password transmission is conducted, an activation code or function code can be added to the beginning of the offline password generated by the user terminal to activate the related functions of the smart device, so that the user can control the state of the smart device, after adding a periodic password on the smart device. The specific contents and format of the activation code or function code can be selected depending on the actual situation, and are not limited to the embodiments of the present disclosure.

Specifically, after the first electronic device generates the password, the first electronic device and the second electronic device need to perform a handshake interaction, so as to indicate whether the password generated by the first electronic device can be used on the second electronic device through the handshake interaction. If a confirmation success message is sent to the second electronic device, it means that it can be used on the second electronic device, thereby indicating that the password has been successfully generated to the second electronic device, and the second electronic device can use the password. For example, the first electronic device is a terminal, and the second electronic device is a door lock, and a password is generated by the terminal and then sent to the door lock, thereby controlling the door lock based on the password, such as controlling the closing and opening of the door lock. The process of the handshake interaction between the first electronic device and the second electronic device is as follows:

After receiving the password, the second electronic device sends a reception success message to the first electronic device. The reception success message is used to indicate that the second electronic device has received the password and can correctly parse the password. That is, in actual applications, the first electronic device encrypts the password and then sends it to the second electronic device. For example, the first electronic device can use but is not limited to the AES (Advanced Encryption Standard) peer-to-peer encryption method to encrypt the password, and the first electronic device may employ, but is not limited to, BLE (Bluetooth Low Energy), Zigbee, and other communication protocols to interact with the second electronic device during handshake interaction.

The format of the reception success message can be negotiated in advance. For example, it can be expressed in but is not limited to the binary format. For example, 1 means successful reception, and 0 means a reception failure.

The first electronic device sends a confirmation success message to the second electronic device, and the confirmation success message is used to indicate that the password has been successfully generated to the second electronic device.

If the second electronic device sends a reception success message, the first electronic device may feed back a confirmation success message to the second electronic device at this time to indicate that the password can be used within the time of use, and after receiving the confirmation success message, the second electronic device encrypts and stores the password. For example, the second electronic device encrypts the password by obfuscating it, and then stores it.

If acquiring a reception failure message sent by the second electronic device, the first electronic device may send the password to the second electronic device multiple times, and if the reception failure message is still sent after the password has been sent the preset number of times, a preset operation will be performed. The preset operation may be sending a prompt message to indicate that the second electronic device is malfunctioning and/or the data interaction between the second electronic device and the first electronic device fails.

Here, it should be noted that the first electronic device can be used as a controlled device. That is, the first electronic device can not only generate a password, but also be controlled based on the password. Taking the door lock as the first electronic device as an example, a password is generated through the processor, display screen, camera, sound collection device, etc., of the door lock, and when the password is stored in the storage device of the door lock, the processor and the storage device perform the aforementioned handshake interaction to determine whether the generated password can be used.

It can be seen from the above technical solution that after the password content input by the user and the repetition type input by the user and/or the specific time input by the user are acquired, the time of use of the password content is acquired based on the repetition type input by the user and/or the specific time input by the user; then, based on the password content, the time of use of the password content, and the generation timestamp, a password is generated and sent; if a reception success message sent by the second electronic device is acquired, a confirmation success message is sent to the second electronic device; thus, it can be confirmed that the second electronic device has accurately received the password by multiple handshake interactions between the first electronic device and the second electronic device; and it is notified that the password is effective by the multiple handshake interactions; thus, the security of the password is improved.

Next, taking the second electronic device (e.g., a smart device) as the controlled device, it is explained how to use the password having the time of use (i.e., the preset periodic password) generated by the first electronic device. The process is as shown in FIG. 5, which shows a password verification method provided by an embodiment of the present disclosure. The method may include the following steps.

In S501, the processor may acquire the input password entered by the user on the second electronic device.

The input password can be any of a number, a fingerprint, a sound, an image, etc., and the input password is the password that the user plans to use to control the second electronic device. The input method of the input password depends on the form of the input password. For example, the input password is a number in the above number, fingerprint, sound, image, etc., and then the input method of the input password can be any one of voice input, key input, and handwriting input. In some embodiments, the input methods of various forms of input passwords are not explained one by one.

In S502, in response to the input password being the same as the preset periodic password, the processor may acquire the first input time of the input password, where the preset periodic password is sent by the first electronic device to the second electronic device and becomes valid once at a specific time interval.

That is, the preset periodic password is generated in advance by the first electronic device and sent to the second electronic device, so that the second electronic device can be controlled based on the preset periodic password at a specific time interval, and the specific preset periodic password is the password that includes the password content and the time of use of the password content in the method shown in FIG. 1 and FIG. 2 above. The password content is used to verify the input password. If the content of the input password and the password content in the preset periodic password are the same, it means that the input password is the same as the preset periodic password.

The time of use of the password content is used to limit the password content in the preset periodic password to be valid once each time after a predetermined time has passed and limit the range of the time of use in which it will be valid once (for details, see the above embodiments). Therefore, if the input password and the preset periodic password are the same, it is needed to acquire the first input time of the input password to verify whether the input password is within the range of the time of use in which the preset periodic password becomes valid once. If it is within the range, it is indicated that the first input time can be used to control the second electronic device based on the preset periodic password.

In some embodiments, the processor may compare, based on the time of use of the preset periodic password, the input time with an effective time for the preset periodic password to obtain a comparison result; and in response to the comparison result that the input time is within the effective time for the preset password, the processor may determine to switch the state of the smart device based on the password content. For instance, the processor may determine which state of the smart device to be switched based on a password type corresponding to the password content, as described in operation S201.

The first input time of the input password is the time when the second electronic device acquires the input password, and this time is the local time of the second electronic device. For example, if the input password is acquired at 13:00 on Oct. 15, 2018, then the first input time is 13:00 on Oct. 15, 2018.

In S503, in response to the first input time being within the range of the time of use in which the preset periodic password becomes valid once, the processor may control the second electronic device based on the input password.

If the first input time is within the range of the time of use in which the preset periodic password becomes valid once, it means that not only the content of the input password is the same as the password content in the preset periodic password, but also the input password is at the time when the preset periodic password can be used. At this time, the second electronic device can be controlled based on the input password. The specific operations that control the second electronic device can be preset, and will not be described In some embodiments.

The method of verifying whether the first input time is within the range of the time of use in which the preset periodic password becomes valid once is as follows:

If the first input time is within the single-day effective time when it becomes valid once, verify whether the first input time is within the date/day of a week when it becomes valid once.

If the first input time is within the date/day of a week when it becomes valid once, verify whether the first input time meets an interval requirement of a specific time.

If the first input time meets the interval requirement of a specific time, it is determined that the first input time is within the range of the time of use in which the preset periodic password becomes valid once.

Refer to the above method embodiment for the description of the single-day effective time, date/day of a week, and specific time, which will not be described In some embodiments. Here, an example is used to describe the verification process. For example, the time of use of the password content in the preset periodic password is 8:00 to 17:00 on the 1st, 3rd, and 4th every 2 months and the generation timestamp of the preset periodic password is Oct. 12, 2018, and then the password content in the preset periodic password will be valid for the first time from 8:00 to 17:00 on January 1, 3, and 4, 2019, for the second time from 8:00 to 17:00 on March 1, 3, and 4, 2019, for the third time from 8:00 to 17:00 on May 1, 3, and 4, 2019, and so on.

If the first input time is 14:00 on Mar. 1, 2019, 14:00 is within the single-day effective time of 8:00 to 17:00, and the 1st is within the date of being once effective, and April also meets the interval requirement of the specific time. Thus, it can be determined that the first input time is within the range of the time of use in which the preset periodic password becomes valid once. If the first input time is 19:00 on Mar. 1, 2019 or Mar. 5, 2019 or April 2019, it is determined that the first input time is not within the range of the time of use in which the preset periodic password becomes valid once.

In some embodiments, verifying whether the first input time meets an interval requirement of a specific time needs to be based on the interval requirement denoting any of the months, weeks, and days as an interval, and the process is as follows:

If the interval requirement of the specific time denotes that it becomes valid once every X months, the months from the sending time of the preset periodic password (the sending time is the above-mentioned generation timestamp) to the first input time as an interval is acquired, and if the months as an interval can be exactly divided by X, it is determined that the first input time meets the interval requirement of the specific time, in which the calculation method of the months as an interval is: the month of the first input time+12*(the year of the first input time−the year of the generation timestamp)−the month of the generation timestamp; and X is a natural number greater than or equal to 1.

If the interval requirement of the specific time denotes that it becomes valid once every Y weeks or every Z days, the first timestamp at 0:00 on the day of the sending time of the preset periodic password (the sending time is the above-mentioned generation timestamp) and the second timestamp of the first input time are acquired, and the timestamp of the interval between the second timestamp and the first timestamp is also acquired. If the timestamp as the interval can be exactly divided by the timestamp indicated by Y weeks or Z days, it is determined that the first input time meets the interval requirement of the specific time. X, Y and Z are all natural numbers greater than or equal to 1.

Specifically, if the interval requirement of the specific time denotes that it becomes valid once every Y weeks, the first timestamp is the timestamp at 0:00 of the week indicated by the generation timestamp, and the timestamp of the interval between the second timestamp and the first timestamp is: the second timestamp−the first timestamp; if the interval requirement of the specific time denotes that it becomes valid once every Z days, the first timestamp is the timestamp at 0:00 of the generation timestamp, and the corresponding timestamp of the interval between the second timestamp and the first timestamp is: the second timestamp−the first timestamp.

In some embodiments, the processor may also determine a plurality of effective dates when the preset periodic password is valid. For example, the processor may determine the plurality of effective dates based on the predetermined time and the first working time (or the generation time) of the periodic password. The processor may further compare the input time of the first password information with the time range and the effective dates. If the input time is within the time range and is on one of the effective dates, the processor may determine that the input time of the first password information is within the time of use in which the periodic password is valid.

It should be noted that the preset periodic password has the above password validity period, but there is a situation where after the password validity period expires, the preset periodic password is still stored in the preset password library. Thus, after the input password is acquired, the processor may compare the first input time of the input password with the password validity period, and if the first input time exceeds the password validity period, it is forbidden to control the second electronic device based on the input password.

It can be seen from the above technical solution that if the acquired input password is the same as the preset periodic password, the first input time of the input password is acquired, and if the first input time is within the range of the time of use in which the preset periodic password becomes valid once, then the first electronic device is controlled based on the input password, in which the preset periodic password becomes valid once at a specific time interval, and if the acquired input password is the same as the preset periodic password, it means that the acquired input password is a periodic password, and then if it is needed to periodically control the first electronic device based on a periodic password, the same specific time of the preset periodic password can be set, so that the user requirement of controlling the second electronic device once at a specific time interval is satisfied by this periodic password.

FIG. 6 shows a password verification method provided by an embodiment of the present disclosure, which describes verifying whether the first input time is within the range of the time of use in which the preset periodic password becomes valid once, and may include the following steps.

In S601, the processor may acquire an input password; the input password is a password entered by the user on the second electronic device.

In S602, in response to the input password being the same as the preset periodic password, the processor may acquire a first input time of the input password, where the preset periodic password is sent by the first electronic device to the second electronic device, and becomes valid once at a specific time interval.

The principles of the execution processes of the above-mentioned S601 and S602 are the same as those of the above-mentioned S501 and S502, and will not be repeated here.

In S603, the processor may acquire the repetition type and specific time of the preset periodic password, and verify whether the first input time is within the range of the time of use in which the preset periodic password becomes valid once based on the repetition type and specific time of the preset periodic password.

The repetition type is used to indicate that the password content in the preset periodic password is valid repeatedly periodically by one of months, weeks, and days. If taking effect repeatedly periodically by one of months, weeks and days is adopted, the processor may verify whether it is within the range of the time of use in which the preset periodic password becomes valid once based on the specific time. Refer to the foregoing method embodiment for the specific process, which will not be described here.

In S604, in response to the first input time being within the range of the time of use in which the preset periodic password becomes valid once, the processor may control the second electronic device based on the input password.

The execution process and principle are the same as those of the foregoing S503, and will not be repeated here. And if the first input time is not within the range of the time of use in which the preset periodic password becomes valid once, it is forbidden to control the second electronic device based on the input password.

In S605, in response to the input password being different from the preset periodic password, the processor may determine the password type corresponding to the input password, and control the second electronic device based on the control method of the password type corresponding to the input password.

In some embodiments, the method of determining the password type corresponding to the input password is to compare the content of the input password with the contents of different types of passwords in the preset password library; if the content of the input password is the same as the content of the preset permanent password in the preset password library, determine that the password type corresponding to the input password is permanent, which means that the input password is a permanent password; if the content of the input password is the same as the content of the preset one-time password in the preset password library, determine that the password type corresponding to the input password is one-time, which means that the input password is a one-time password, in which the preset password library is a database storing different types of passwords, and the preset permanent password and the preset one-time password are both sent by the first electronic device to the second electronic device.

After determining the password type corresponding to the input password, the process of controlling the second electronic device based on the control method of the password type is as follows: if the input password is the same as the preset permanent password, control the second electronic device based on the input password. The specific operations of controlling the second electronic device can be determined according to the actual application.

If the input password is the same as the preset one-time password, a second input time of the input password is acquired. If the second input time is within the range of the time of use of the preset one-time password, the second electronic device is controlled based on the input password. That is, the second electronic device can be controlled only if it is within the range of the time of use of the preset one-time password, and the range of the time of use of the preset one-time password includes the start time and the end time, which will not be described In some embodiments.

It can be seen from the above technical solution that if the input password is the same as the preset periodic password, the repetition type and specific time of the preset periodic password are acquired, and based on the repetition type and specific time of the preset periodic password, it is verified whether the first input time is within the range of the time of use in which the preset periodic password becomes valid once, so that the second electronic device is controlled by the preset periodic password within the range of the time of use in which the periodic password becomes valid once; if it is determined that the input password is different from the preset periodic password, it is determined whether the input password is a preset permanent password or a preset one-time password, so that control can be performed based on one of the preset permanent password and the preset one-time password. Thus, multiple types of passwords can be used to control the second electronic device, which improves the flexibility of control to better meet the needs of users.

In addition, the password verification method provided In some embodiments may further include: deleting an expired preset periodic password, and/or if an instruction to delete a periodic password is acquired, deleting the preset periodic password pointed to by the instruction.

One feasible way to delete an expired preset periodic password is to acquire the local time (the current time of the second electronic device) and the password validity period of a preset periodic password; if the local time exceeds the password validity period of the preset periodic password, delete the preset periodic password. For example, if the password validity period of a preset periodic password is 2018.10.15-2018.11.15 but the local time is 2018.11.16, it means that the preset periodic password has expired, and the preset periodic password will be deleted.

One feasible way to acquire an instruction to delete a preset periodic password is to acquire an instruction to delete a preset periodic password issued by the user through the first electronic device, which carries the preset periodic password that the user wants to delete therein. The preset periodic password that the user wants to delete is the password pointed to by the instruction. Another way is: if the local time exceeds the password validity period of a preset periodic password, it means the preset periodic password has expired, and the second electronic device will automatically generate an instruction to delete the preset periodic password, and the preset periodic password pointed to by the instruction is the expired preset periodic password.

It can be seen from the above technical solution that by deleting the expired preset periodic password, the expired preset periodic password can no longer be used to control the second electronic device after the deletion, which improves the security, and by acquiring the instruction to delete a periodic password to delete the preset periodic password pointed to by the instruction, the unwanted preset periodic password can be deleted according to the user's wishes, so that the needs of users are better met.

The password verification method in the foregoing embodiment may further include: reading the preset periodic password from a first storage space, the first electronic device storing the preset periodic password in the first storage space after receiving the preset periodic password; and storing the preset periodic password in a second storage space in the form of a two-dimensional array, and the reading speed of the first storage space being lower than that of the second storage space, so as to read the preset periodic password from the second storage space when verifying the input password, thereby speeding up the speed of acquiring the preset periodic password.

In some embodiments, each element in the two-dimensional array is a field in the preset periodic password. For example, the preset periodic password includes the fields as shown in Table 1 and the password content. The number of the corresponding elements in the two-dimensional array is related to the fields in the preset periodic password and the bytes used by the fields, so as to store the fields in the preset periodic password into the elements of the two-dimensional array. Taking the repetition by months as an example, if it is assumed that the preset periodic password is the i-th preset periodic password received by the second electronic device, the fields in Table 1 are represented by a two-dimensional array as follows:

repeat_type=pwd_period[i−1][0]&0x03, &0x03 is due to the use of only bit 1˜bit 0 of one byte by repeat_type;

start_hour, which represents the start time and is a string of characters, and uses 3 bytes; if one byte is represented using an element in the two-dimensional array, the representation of start_hour needs 3 elements in the two-dimensional array, for example:

The corresponding range of values of start_hour is pwd_period[i−1][1]−pwd_period[i−1][3];

This also applies for end_hour, repeat_period and repeat_interval, which have the following corresponding ranges of values respectively: pwd_period[i−1][4]−pwd_period[i−1][6], pwd_period[i−1] [7]−pwd_period[i−1][10], and pwd_period[i−1][11];

create_time, which is an integer, and is calculated as follows:

create_time=(pwd_period[i−1][12]<<24);

create_time+=(pwd_period[i−1][13]<<16);

create_time+=(pwd_period[i−1][14]<<8);

create_time+=(pwd_period[i−1][15]]).

The maximum value of i is N, and N is the total number of preset periodic passwords allowed to be received. In addition, In some embodiments, the password verification method may also provide at least one password modification interface, and the at least one password modification interface is used to modify the preset periodic password, such as adding a preset periodic password and changing a preset periodic password. Changing a preset periodic password includes but is not limited to: changing the content of any field in the preset periodic password. In addition to modifying the preset periodic password, the password modification interface can also be used to change at least one of the preset permanent password and the preset one-time password, which is not described In some embodiments.

For the foregoing method embodiments, for the sake of simple description, they are all expressed as a combination of a series of actions, but those skilled in the art should know that the present disclosure is not limited by the described sequence of actions, because according to the present disclosure, some steps can be performed in other orders or at the same time. Secondly, those skilled in the art should also know that the embodiments described in the specification are all preferred embodiments, and the actions and modules involved are not necessarily required by the present disclosure.

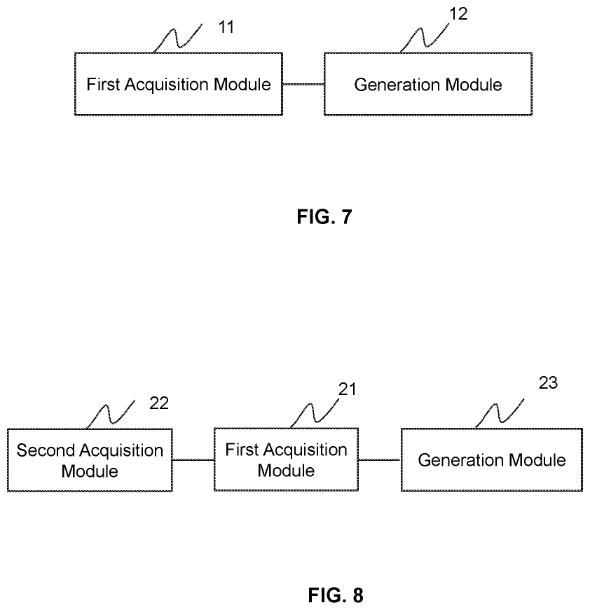

Corresponding to the foregoing embodiment of the password generation method, an embodiment of the present disclosure also provides a password generation device. The structural diagram of the device is as shown in FIG. 7. It may include a first acquisition module 11 and a generation module 12.

The first acquisition module 11 is used to acquire the password content entered by the user and the time of use of the password content entered by the user. The time of use of the password content denotes that the password content is allowed to be valid once at a specific time interval, and limits the range of the time of use in which the password content becomes valid once.

It can be understood that the password content is used to control the controlled device. For example, the password content can be one of a number, a fingerprint, a sound, and an image that can control the controlled device. The device can be a first electronic device. That is, the password content is acquired through the password generation device in the first electronic device and the first electronic device is controlled based on the password content. Alternatively, the device is a second electronic device capable of communicating with the first electronic device, for example, directly communicating with the first electronic device or communicating with it by means of a relay device. In this way, the password content can be acquired through the password generation device in the first electronic device and sent to the second electronic device.

And while acquiring the password content, the processor also acquires the time of use of the password content, so as to limit the password content to be valid multiple times repeatedly periodically by the time of use of the password content. The so-called “be valid multiple times repeatedly periodically” refers to taking effect once every a specific time (the specific time denotes the repetition interval) and the range of the time of use in which it becomes valid once.

In some embodiments, the specific time interval may be one of specific months, specific weeks, and specific days. The range of the time of use of being effective once depends on the specific time interval. For example, if the time of use of the password content denotes that the password content is allowed to be valid once every specific months, the time of use of the password content also limits the date when it will be valid once and the single-day effective time. The date when it will be valid once and the single-day effective time limits the range of the time of use in which it will be valid once. In other words, the time of use of the password content may also limit the date when the password content becomes effective in the specific months and the effective time at that date, in addition to the limitation that the repetition interval is specific months. The “specific months” is used to indicate the number of months as an interval.

If the time of use of the password content denotes that the password content is allowed to be valid once every specific weeks, the time of use of the password content also limits on which day of a week it will be valid once and the single-day effective time, which limit the range of the time of use in which it will be valid once. In other words, the time of use of the password content may also limit on which day of a week in the specific weeks the password content is made effective and the effective time on that day, in addition to the limitation that the repetition interval is specific weeks. The “specific weeks” is used to indicate the number of weeks.

If the time of use of the password content denotes that the password content is allowed to be valid once every specific days, the time of use of the password content also limits the single-day effective time, and the single-day effective time limits the range of use in which it will be valid once. For specific description, refer to the related description in the method embodiment, which will not be explained In some embodiments.

The generation module 12 is configured to generate and send a password based on the password content, the time of use of the password content and the generation timestamp, in which the generation timestamp is the sending time of the password, and the generation timestamp is used to verify whether the password is within the range of the time of use in which it becomes valid once when control is performed based on the password.

In some embodiments, the password generated by the generation module 12 may be composed of the password content, the time of use of the password content, and the generation timestamp. The corresponding feasible method by which the generation module 12 generates a password is as follows:

The generation module 12 is specifically configured to use the password content and the time of use of the password content as the first part of the password, and is also specifically used to record the sending time of the first part as the generation timestamp, and use the generation timestamp as the second part of the password. The sending of the first part and the second part of the password is performed by the sending module in the password generation device provided In some embodiments. For specific description, refer to the relevant description in the method embodiment, which will not be described In some embodiments.

It can be seen from the above technical solution that after the password content entered by the user and the time of use of the password content entered by the user are acquired, a password is generated based on the password content, the time of use of the password content and the generation timestamp, in which the time of use of the password content denotes that the password content is allowed to be valid once at a specific time interval, and limits the range of the time of use in which the password content will be valid once. This means that the password generated based on the password content is a periodic password, thereby adding another type of password on the basis of the existing permanent password and one-time password. Thus, it is possible to satisfy the user requirement of controlling the controlled device (for example, the second electronic device capable of communicating with the first electronic device) once at a specific time interval by this type of periodic password.

FIG. 8 shows another password generation device provided by an embodiment of the present disclosure, which may include: a first acquisition module 21, a second acquisition module 22, and a generation module 23.

The first acquisition module 21 is configured to acquire the password content entered by the user and the time of use of the password content entered by the user. The time of use of the password content denotes that the password content is allowed to be valid once at a specific time interval, and limits the range of the time of use in which the password content becomes valid once.

The second acquisition module 22 is configured to acquire the repetition type entered by the user and/or the specific time entered by the user. The time of use of the password content denotes that the password content is allowed to be valid once at a specific time interval, and limits the range of the time of use in which the password content becomes valid once. The corresponding first acquisition module 21 is specifically configured to acquire the time of use of the password content based on the repetition type and/or the specific time. For the specific process, refer to the relevant description in the method embodiment.

The repetition type is used to denote that the password content is repeated by one of months, weeks, and days, so as to limit the time of use of the password content by the repetition type entered by the user and/or the specific time entered by the user. In this way of the user entering the repetition type and/or the specific time, the user is enabled to freely and flexibly set the time of use.

In some embodiments, the specific time input by the user is the above repetition interval. For example, if the time of use of the password content is Wednesday every 4 weeks, the specific time is 4 weeks. The time of use of the password content is limited by the user input to satisfy the actual requirements for the time of use of the password content. In addition to the features of the repetition type and the specific time that denotes the repetition interval can be input by the user, the repetition period, start time and end time on which the acquisition of the time of use is based can also be input by the user, so that the repetition type, repetition interval, repetition period, start time and end time may be included in the time of use of the password content. Refer to the foregoing method embodiment for the description of the repetition type, repetition interval, repetition period, start time, and end time, which will not be described In some embodiments.

The method for the user to enter the password content and time of use may be, but is not limited to: displaying an interface in the display area of the first electronic device, which provides controls for entering the password content and time of use, so that the user can enter the password content and time of use through these controls. Of course, the password content and time of use can also be directly manually input by the user without the interface, or after a voice carrying the password content and time of use therein is acquired, the password content and time of use can be recognized from the voice, or an image containing the password content and the time of use can be collected by the first electronic device. This embodiment does not limit the input method of the password content and time of use.

The generation module 23 is configured to generate and send a password based on the password content, the time of use of the password content, and the generation timestamp, in which the generation timestamp is the sending time of the password, and the generation timestamp is used to verify whether the password is within the range of the time of use in which it becomes valid once when control is performed based on the password.

The execution process and principle of the above generation module 23 are the same as those of the above generation module 12, and will not be repeated here. Here, a brief description of the components of the password is provided. In some embodiments, the components of the password include the password content, the time of use of the password content, and the generation timestamp, in which the time of use of the password content includes the repetition type, the repetition period, the repetition interval, the start time, and the end time. For details, refer to the relevant description in the method embodiment, which is not described In some embodiments.

It can be seen from the above technical solution that after the password content input by the user and the repetition type input by the user and/or the specific time input by the user are acquired, the time of use of the password content is acquired based on the repetition type input by the user and/or the specific time input by the user. Then, based on the password content, the time of use of the password content, and the generation timestamp, a password is generated and sent.

In addition, the aforementioned sending module is further configured to send a confirmation success message to the second electronic device if acquiring a reception success message sent by the second electronic device, in which the confirmation success message is used to indicate that the password has been successfully generated to the second electronic device.

That is, after the first electronic device generates a password, the first electronic device and the second electronic device need to perform a handshake interaction, so as to indicate whether the password generated by the first electronic device can be used on the second electronic device through the handshake interaction. If a confirmation success message is sent to the second electronic device, it means that it can be used on the second electronic device, thereby indicating that the password has been successfully generated to the second electronic device, and the second electronic device can use the password. For example, the first electronic device is a terminal, and the second electronic device is a door lock, and a password is generated by the terminal and then sent to the door lock, thereby controlling the door lock based on the password, such as controlling the closing and opening of the door lock. The process of the handshake interaction between the first electronic device and the second electronic device is as follows:

After receiving the password, the second electronic device sends a reception success message to the first electronic device. The reception success message is used to indicate that the second electronic device has received the password and can correctly parse the password. That is, in actual applications, the first electronic device encrypts the password and sends it to the second electronic device. The form of the reception success message can be negotiated in advance.

The first electronic device sends a confirmation success message to the second electronic device. The confirmation success message is used to indicate that the password has been successfully generated to the second electronic device.

If the second electronic device sends a reception success message, the first electronic device may feed back a confirmation success message to the second electronic device at this time to indicate that the password can be used within the time of use, and after receiving the confirmation success message, the second electronic device encrypts and stores the password. For example, the second electronic device encrypts the password by obfuscating it, and then stores it.

If acquiring a reception failure message sent by the second electronic device, the first electronic device may send the password to the second electronic device multiple times, and if the reception failure message is still sent after the password has been sent the preset number of times, a preset operation will be performed. The preset operation may be sending a prompt message to indicate that the second electronic device is malfunctioning and/or the data interaction between the second electronic device and the first electronic device fails.

Here, it should be noted that the first electronic device can be used as a controlled device. That is, the first electronic device can not only generate a password, but also be controlled based on the password. Taking the door lock as the first electronic device as an example, a password is generated through the processor, display screen, camera, sound collection device, etc., of the door lock, and when the password is stored in the storage device of the door lock, the processor and the storage device perform the aforementioned handshake interaction to determine whether the generated password can be used.

It can be seen from the above technical solution that if a reception success message sent by the second electronic device is acquired, a confirmation success message is sent to the second electronic device; thus, it can be confirmed that the second electronic device has accurately received the password by multiple handshake interactions between the first electronic device and the second electronic device; and it is notified that the password is effective by the multiple handshake interactions; thus, the security of the password is improved.

In addition, this embodiment also provides a storage medium on which a computer program code is stored, and the computer program code implements the above-mentioned password generation methods when executed.

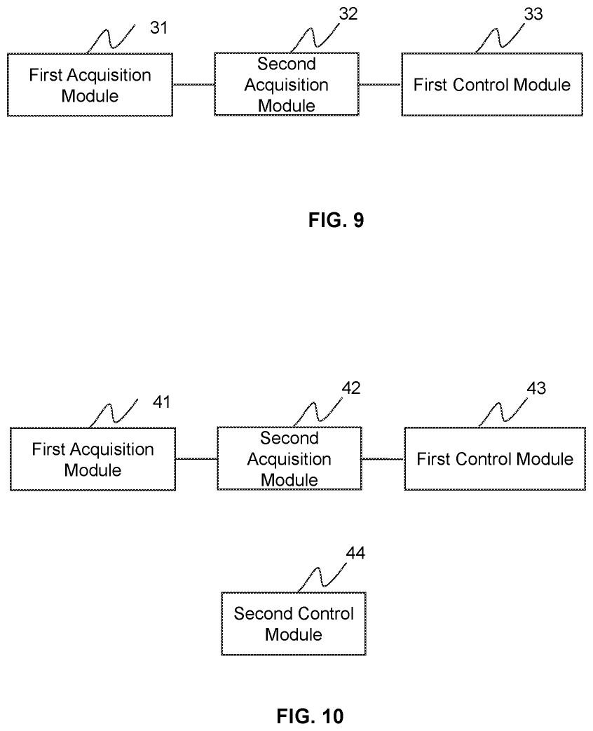

Corresponding to the foregoing embodiment of the password verification method, an embodiment of the present disclosure also provides a password verification device. The structural diagram of the device is as shown in FIG. 9. The device may include a first acquisition module 31, a second acquisition module 32, and a first control module 33.

The first acquisition module 31 is configured to acquire an input password. The input password is a password entered by the user on the second electronic device. The input password can be any of a number, a fingerprint, a sound, an image, etc., and the input password is the password that the user plans to use to control the second electronic device. The input method of the input password depends on the form of the input password. For example, the input password is a number in the above number, fingerprint, sound, image, etc., and then the input method of the input password can be any one of voice input, key input, and handwriting input. The input methods of various forms of input passwords are not limited by the present disclosure.

The second acquisition module 32 is configured to acquire the first input time of the input password if the input password is the same as the preset periodic password. The preset periodic password is sent by the first electronic device to the second electronic device, and the preset periodic password becomes valid once at a specific time interval.

That is, the preset periodic password is generated in advance by the first electronic device and sent to the second electronic device, so that the second electronic device can be controlled based on the preset periodic password at the specific time interval. The specific preset periodic password is the password including the password content and the time of use of the password content in the methods shown in FIG. 3 and FIG. 4 above. The password content is used to verify the input password. If the content of the input password and the password content in the preset periodic password are the same, it means that the input password is the same as the preset periodic password.

The time of use of the password content is used to limit the password content in the preset periodic password to be valid once at a specific time interval and limit the range of the time of use in which it will be valid once (for details, see the above method embodiment). Therefore, if the input password and the preset periodic password are the same, the processor may acquire the first input time of the input password to verify whether the input password is within the range of the time of use in which the preset periodic password becomes valid once. If it is within the range, it is indicated that the first input time can be used to control the second electronic device based on the preset periodic password.

The first input time of the input password is the time when the second electronic device acquires the input password, and this time is the local time of the second electronic device. For example, if the input password is acquired at 13:00 on Oct. 15, 2018, then the first input time is 13:00 on Oct. 15, 2018.

The first control module 33 is configured to control the second electronic device based on the input password if the first input time is within the range of the time of use in which the preset periodic password becomes valid once.

If the first input time is within the range of the time of use in which the preset periodic password becomes valid once, it means that not only the content of the input password is the same as the password content in the preset periodic password, but also the input password is at the time when the preset periodic password can be used. At this time, the second electronic device can be controlled based on the input password. The specific operations that control the second electronic device can be preset, and will not be described In some embodiments.

The verification of whether the first input time is within the range of the time of use in which the preset periodic password becomes valid once can be completed by the third acquisition module and the verification module in the password verification device provided In some embodiments.

The third acquisition module is configured to acquire the repetition type and specific time of the preset periodic password. The repetition type is used to indicate that the password content in the preset periodic password is valid repeatedly periodically by one of months, weeks, and days. If one of months, weeks, and days is adopted for taking effect repeatedly periodically, the processor may verify whether it is within the range of the time of use in which the preset periodic password becomes valid once. Refer to the foregoing method embodiment for the specific process, which will not be described here.

The verification module is configured to verify whether the first input time is within the range of the time of use in which the preset periodic password becomes valid once based on the repetition type and the specific time of the preset periodic password. One way to verify is as follows:

If the first input time is within the single-day effective time of being effective once, verify whether the first input time is within the date/day of a week of being effective once; if the first input time is within the date/day of a week of being effective once, verify whether the first input time meets an interval requirement of a specific time; if the first input time meets the interval requirement of the specific time, it is determined that the first input time is within the range of the time of use in which the preset periodic password becomes valid once, and the first control module 33 is triggered to control the second electronic device based on the input password. Refer to the foregoing method embodiment for the description of the single-day effective time, the date/day of a week, and the specific time, which will not be described In some embodiments.

In some embodiments, verifying whether the first input time meets an interval requirement of a specific time by the verification module needs to be based on the interval requirement denoting any of the months, weeks, and days as an interval, and the process is as follows:

If the interval requirement of the specific time denotes that it becomes valid once every X months, the months from the sending time of the preset periodic password (the sending time is the above-mentioned generation timestamp) to the first input time as an interval is acquired, and if the months as an interval can be exactly divided by X, it is determined that the first input time meets the interval requirement of the specific time, in which the calculation method of the months as an interval is: the month of the first input time+12*(the year of the first input time−the year of the generation timestamp)−the month of the generation timestamp; and X is a natural number greater than or equal to 1.

If the interval requirement of the specific time denotes that it becomes valid once every Y weeks or every Z days, the first timestamp at 0:00 on the day of the sending time of the preset periodic password (the sending time is the above-mentioned generation timestamp) and the second timestamp of the first input time are acquired, and the timestamp of the interval between the second timestamp and the first timestamp is also acquired. If the timestamp as the interval can be exactly divided by the timestamp indicated by Y weeks or Z days, it is determined that the first input time meets the interval requirement of the specific time. X, Y, and Z are all natural numbers greater than or equal to 1.

It should be noted that the preset periodic password has the above password validity period, but there is a situation where after the password validity period expires, the preset periodic password is still stored in the preset password library. Thus, after the input password is acquired, the processor may compare the first input time of the input password with the password validity period, and if the first input time exceeds the password validity period, it is forbidden to control the second electronic device based on the input password.

It can be seen from the above technical solution that if the acquired input password is the same as the preset periodic password, the first input time of the input password is acquired, and if the first input time is within the range of the time of use in which the preset periodic password becomes valid once, then the first electronic device is controlled based on the input password, in which the preset periodic password becomes valid once at a specific time interval, and if the acquired input password is the same as the preset periodic password, it means that the acquired input password is a periodic password, and then if it is needed to periodically control the first electronic device based on a periodic password, the same specific time of the preset periodic password can be set, so that the user requirement of controlling the second electronic device once at a specific time interval is satisfied by this periodic password.

FIG. 10 shows another password verification device provided by an embodiment of the present disclosure. The device may include a first acquisition module 41, a second acquisition module 42, a first control module 43, and a second control module 44.

The first acquisition module 41 is configured to acquire an input password. The input password is a password input by the user on the second electronic device.

The second acquisition module 42 is configured to acquire a first input time of the input password if the input password is the same as the preset periodic password. The preset periodic password is sent by the first electronic device to the second electronic device, and becomes valid once at a specific time interval.

The first control module 43 is configured to control the second electronic device based on the input password if the first input time is within the range of the time of use in which the preset periodic password becomes valid once.

The execution processes and principles of the first acquisition module 41, the second acquisition module 42, and the first control module 43 are the same as those of the first acquisition module 31, the second acquisition module 32, and the first control module 33, and will not be repeated here.

The second control module 44 is configured to determine the password type corresponding to the input password and control the second electronic device based on the control method of the password type corresponding to the input password if the input password is different from the preset periodic password.

In some embodiments, the method of determining the password type corresponding to the input password is to compare the content of the input password with the contents of different types of passwords in the preset password library; if the content of the input password is the same as the content of the preset permanent password in the preset password library, determine that the password type corresponding to the input password is permanent, which means that the input password is a permanent password; if the content of the input password is the same as the content of the preset one-time password in the preset password library, determine that the password type corresponding to the input password is one-time, which means that the input password is a one-time password, in which the preset password library is a database storing different types of passwords, and the preset permanent password and the preset one-time password are both sent by the first electronic device to the second electronic device.

After determining the password type corresponding to the input password, the process of controlling the second electronic device based on the control method of the password type is as follows: if the input password is the same as the preset permanent password, control the second electronic device based on the input password. The specific operations of controlling the second electronic device can be determined according to the actual application.

If the input password is the same as the preset one-time password, a second input time of the input password is acquired. If the second input time is within the range of the time of use of the preset one-time password, the second electronic device is controlled based on the input password. That is, the second electronic device can be controlled only if it is within the range of the time of use of the preset one-time password, and the range of the time of use of the preset one-time password includes the start time and the end time, which will not be described In some embodiments.

It can be seen from the above technical solution that if the input password is the same as the preset periodic password, the repetition type and specific time of the preset periodic password are acquired, and based on the repetition type and specific time of the preset periodic password, it is verified whether the first input time is within the range of the time of use in which the preset periodic password becomes valid once, so that the second electronic device is controlled by the preset periodic password within the range of the time of use in which the periodic password becomes valid once; if it is determined that the input password is different from the preset periodic password, it is determined whether the input password is a preset permanent password or a preset one-time password, so that control can be performed based on one of the preset permanent password and the preset one-time password. Thus, multiple types of passwords can be used to control the second electronic device, which improves the flexibility of control to better meet the needs of users.

In addition, the password verification device provided In some embodiments may further include a deletion module, which is configured to delete an expired preset periodic password, and/or if acquiring an instruction to delete a periodic password, delete the preset periodic password pointed to by the instruction.

One feasible way to delete an expired preset periodic password by the deletion module is to acquire the local time (the current time of the second electronic device) and the password validity period of a preset periodic password; if the local time exceeds the password validity period of the preset periodic password, delete the preset periodic password. For example, if the password validity period of a preset periodic password is 2018.10.15-2018.11.15 but the local time is 2018.11.16, it means that the preset periodic password has expired, and the preset periodic password will be deleted.

One feasible way to acquire an instruction to delete a preset periodic password is to acquire an instruction to delete a preset periodic password issued by the user through the first electronic device, which carries the preset periodic password that the user wants to delete therein. The preset periodic password that the user wants to delete is the password pointed to by the instruction. Another way is: if the local time exceeds the password validity period of a preset periodic password, it means the preset periodic password has expired, and the second electronic device will automatically generate an instruction to delete the preset periodic password, and the preset periodic password pointed to by the instruction is the expired preset periodic password.

It can be seen from the above technical solution that by deleting the expired preset periodic password, the expired preset periodic password can no longer be used to control the second electronic device after the deletion, which improves the security, and by acquiring the instruction to delete a periodic password to delete the preset periodic password pointed to by the instruction, the unwanted preset periodic password can be deleted according to the user's wishes, so that the needs of users are better met.

The various password verification devices shown in the above embodiments may further include a storage module configured to read the preset periodic password from a first storage space, and store the preset periodic password in the form of a two-dimensional array into a second storage space, in which the reading speed of the first storage space is lower than the reading speed of the second storage space, so as to read the preset periodic password from the second storage space when verifying the input password, so as to speed up the acquisition speed of the preset periodic password. Refer to the foregoing method embodiment for the specific description, which will not be described In some embodiments.

In addition, this embodiment also provides a storage medium on which a computer program code is stored, and the computer program code implements the above-mentioned password verification methods when executed.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “unit,” “module,” or “system.” Furthermore, aspects of the present disclosure may take the form of a computer program product embodied in one or more computer readable media having computer-readable program code embodied thereon.

A computer readable signal medium may include a propagated data signal with computer readable program code embodied therein, for example, in baseband or as part of a carrier wave. Such a propagated signal may take any of a variety of forms, including electromagnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in a combination of one or more programming languages, including an object oriented programming language such as Java, Scala, Smalltalk, Eiffel, JADE, Emerald, C++, C#, VB. NET, Python or the like, conventional procedural programming languages, such as the “C” programming language, Visual Basic, Fortran 2003, Perl, COBOL 2002, PHP, ABAP, dynamic programming languages such as Python, Ruby, and Groovy, or other programming languages. The program code may execute entirely on the user's computer, partly on the user's computer, as a stand-alone software package, partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped in a single embodiment, figure, or description thereof to streamline the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

We claim:

1. A system for controlling a smart device, comprising:
a storage device storing a set of instructions; and
one or more processors communicating with the storage device, wherein when the set of instructions are executed, the one or more processors are configured to cause the system to:
acquire a state switching instruction, the state switching instruction including first password information;
acquire information of a preset periodic password related to the smart device, wherein the preset periodic password becomes valid each time after a predetermined time has passed; and
determine whether to switch a state of the smart device based on the information of the password and the information of the preset periodic password.

2. The system of claim 1, wherein the information of the preset periodic password includes a time of use indicating the predetermined time and a time range in which the preset periodic password is valid.

3. The system of claim 2, wherein the time of use denotes that the password is allowed to be valid every specific months, every specific weeks, or every specific days.

4. The system of claim 2, wherein the predetermined time relates to a periodic time interval of specific months. and a day number, the day number indicating one or more specific days within each month, wherein the preset periodic password becomes valid, during the time range on one or more days corresponding to the day number, each time after the specific months have passed.

5. The system of claim 2, wherein the predetermined time relates to a periodic time interval of specific weeks and a weekday number, the weekday number indicating one or more days within each week, wherein the preset periodic password becomes valid, during the time range on one or more days corresponding to the weekday number, each time after the specific weeks have passed.

6. The system of claim 2, wherein the predetermined time relates to a periodic time interval of specific days, wherein the preset periodic password becomes valid, during the time range on one or more days, each time after the specific days have passed.

7. The system of claim 2, wherein to determine whether to switch a state of the smart device based on the information of the password and the information of the preset periodic password, the one or more processors are configured to cause the system to:
compare the first password information with the preset periodic password information to obtain a first comparison result;
in response to the first comparison result that a password content of the first password information is the same as a password content of the preset periodic password, acquire an input time of the first password information;
compare, based on the time of use of the preset periodic password, the input time with an effective time for the preset periodic password to obtain a second comparison result; and
in response to the second comparison result that the input time is within the effective time for the preset periodic password, switch the state of the smart device based on the password content.

8. The system of claim 7, wherein the information of the preset periodic password includes a first working time, and an effective period, wherein:
the preset periodic password starts to be valid for the first time at the first working time, and
the preset periodic password is invalid outside the effective period.

9. The system of claim 8, wherein the predetermined time relates to specific weeks and a weekday number, the weekday number indicating one or more days within each week, wherein the preset periodic password becomes valid, during the time range on one or more days corresponding to the weekday number, each time after the specific weeks have passed; and
to compare the input time with the effective time of the preset periodic password to obtain the second comparison result, the one or more processors are configured to cause the system to:
determine whether the input time conforms to the weekday number;
in response to determining that the input time conforms to the weekday number, determine whether the input time conforms to the periodic time interval; and
in response to determining that the input time conforms to the periodic time interval, obtain the second comparison result that the input time is within the effective time for the preset periodic password.

10. The system of claim 9, wherein to determine whether the input time conforms to the periodic time interval, the one or more processors are configured to cause the system to:
determine a time difference between the first working time of the preset periodic password and the input time;
determine a count of target weeks included in the time difference;
determine a count of reference weeks in the periodic time interval;
determine whether the count of target weeks is divisible by the count of reference weeks; and
in response to determining that the count of target weeks is divisible by the count of reference weeks, determine that the input time conforms to the periodic time interval.

11. The system of claim 8, wherein the predetermined time relates to specific months and a day number, the day number indicating one or more specific days within each month, wherein the preset periodic password becomes valid, during the time range on one or more days corresponding to the day number, each time after the specific months have passed; and
to compare the input time with the effective time of the preset periodic password to obtain the second comparison result, the one or more processors are configured to cause the system to:
determine whether the input time conforms to the day number;
in response to determining that the input time conforms to the day number, determine whether the input time conforms to the periodic time interval; and
in response to determining that the input time conforms to the periodic time interval, obtain the second comparison result that the input time is within the effective time for the preset periodic password.

12. The system of claim 11, wherein to determine whether the input time conforms to the periodic time interval, the one or more processors are configured to cause the system to:
determine a time difference between the first working time of the preset periodic password and the input time;
determine a count of target months included in the time difference;
determine a count of reference months in the periodic time interval;
determine whether the count of target months is divisible by the count of reference months; and
in response to determining that the count of target months is divisible by the count of reference months, determine that the input time conforms to the periodic time interval.

13. The system of claim 8, wherein the one or more processors are further configured to cause the system to:
determine whether the input time is within the effective period; and
in response to a determination that the input time is not within the effective period, delete the preset periodic password.

14. The system of claim 8, wherein the information of the preset periodic password further includes a suspending duration, wherein the preset periodic password is temporarily invalid during the suspending duration.

15. A system for generating a periodic password for a smart device, comprising:
a storage device storing a set of instructions; and
one or more processors communicating with the storage device, wherein when the set of instructions are executed, the one or more processors are configured to cause the system to:
obtain, by a first electronic device, a user input indicating a password content and a time of use of the password content, wherein the time of use indicates that the password content is valid within a time range each time after a predetermined time has passed; and
generate, by the first electronic device, the periodic password based on the password content, the time of use, and a generation time related to the password content.

16. The system of claim 15, wherein to generate, by the first electronic device, the periodic password based on the password content, the time of use, and the generation time, the one or more processors are configured to cause the system to:
send, by the first electronic device at a sending time, a first part of the periodic password to the second electronic device, the first part of the password including the password content and the time of use;
designate the sending time of the first part of the periodic password as the generation time; and
send a second part of the periodic password to the second electronic device, the second part of the password including the generation time.

17. The system of claim 15, wherein the predetermined time relates to a periodic time interval of specific months and a day number, the day number indicating one or more specific days within each month, wherein the preset periodic password becomes valid, during the time range on one or more days corresponding to the day number, each time after the specific months have passed.

18. The system of claim 15, wherein the predetermined time relates to a periodic time interval of specific weeks and a weekday number, the weekday number indicating one or more days within each week, wherein the preset periodic password becomes valid, during the time range on one or more days corresponding to the weekday number, each time after the specific weeks have passed.

19. The system of claim 15, wherein the predetermined time relates to a periodic time interval of specific days, wherein the preset periodic password becomes valid, during the time range on one or more days, each time after the specific days have passed.

20. The system of claim 16, wherein the one or more processors are configured to cause the system to:
receive, by the first electronic device, a notification from the second electronic device that indicates the second electronic device has received the first part and the second part of the periodic password; and
determine, by the first electronic device, that the periodic password is successfully generated.
